(19) United States
(12) Patent Application Publication
(10) Pub. No.: US 2024/0427093 A1
(43) Pub. Date: Dec. 26, 2024

(54) SENSOR FOR FIBER OPTIC CLOSURES

(71) Applicant: CommScope Technologies LLC, Hickory, NC (US)

(72) Inventors: Kristof VASTMANS, Boutersem (BE); Johan GEENS, Bunsbeek (BE); Pieter VERMEULEN, Westerlo (BE)

(73) Assignee: CommScope Technologies LLC, Hickory, NC (US)

(21) Appl. No.: 18/708,180

(22) PCT Filed: Nov. 8, 2022
(86) PCT No.: PCT/US2022/049316

§ 371 Date: May 7, 2024

Related U.S. Application Data
(60) Provisional application No. 63/277,095, filed on Nov. 8, 2021.
(60) Provisional application No. 63/301,841, filed on Jan. 21, 2022.
(60) Provisional application No. 63/401,969, filed on Aug. 29, 2022.

(51) Int. Cl. G02B 6/42; G01D 5/353

(52) U.S. Cl. CPC G02B 6/4251; G01D 5/35354

(57) ABSTRACT

A sensor system detects activity at a fiber optic closure, including whether the fiber optic closure has been opened, or whether movable components within the closure are moved. An optical sensor capable of sensing mechanical movement, and an OTDR signal communicates the sensed movement to a remote location, such as a central office.

### CROSS-REFERENCE TO RELATED APPLICATION

This application is being filed on Nov. 8, 2022 as a PCT International Patent Application and claims the benefit of U.S. Provisional Application No. 63/277,095, filed on Nov. 8, 2021, and claims the benefit of U.S. Patent Application Ser. No. 63/301,841, filed on Jan. 21, 2022 and claims the benefit of U.S. Patent Application Ser. No. 63/401,969, filed on Aug. 29, 2022, the disclosures of which are hereby incorporated herein by reference in their entireties.

### TECHNICAL FIELD

The present disclosure relates generally to enclosures such as telecommunications enclosures. More particularly, the present disclosure relates to a sensor for detecting activity of a telecommunications enclosure.

### BACKGROUND

Telecommunications systems typically employ a network of telecommunications cables capable of transmitting large volumes of data and voice signals over relatively long distances. Telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures (or “closures”) are adapted to house and protect telecommunications components such as splices, termination panels, power splitters, wave division multiplexers, fiber management trays, cable organizing and routing components, etc.

Typically, telecommunications closures house a fiber organizing assembly having equipment for organizing fibers, storing fibers, and optically connecting provider side fibers to subscriber side fibers. A given closure can accommodate different types of optical connections between fibers, such as connector to connector connections and fiber splices.

Fiber optic closures receive cables extending to and from the closure, while protecting the internal cables and connections in a sealed environment. The closure is typically re-enterable wherein the seal is de-activated, and then later re-activated.

There is a need to monitor activity with respect to the closure over time. U.S. Pat. Nos. 9,741,229, 9,892,614, 10,034,546, and 10,694,850 concern optical sensors and monitoring devices.

### SUMMARY

In one aspect, a sensor system is provided for detecting activity at a fiber optic closure. One example is whether the fiber optic closure has been opened. Another example is whether movable components within the closure are moved.

The sensor system can monitor authorized movements with respect to the closure, such as opening and closing the closure, or moving components within the closure. In this system, tracking of technician activity can be monitored. The sensor system can also monitor unauthorized movements with respect to the closure. In some implementations, the sensor can track opening/closing of an access opening of the closure. In other implementations, the sensor can track movement of one or more components within the closure. In still other implementations, the sensor can track actuation/de-actuation of a gel block within the closure. In still other implementations, the sensor can track opening/closing of a housing (e.g., a handhole closure) surrounding the closure.

In one aspect, the present disclosure relates to an optical sensor, in particular an optical sensor capable of sensing mechanical movement, and an optical sensor assembly and a monitoring device having the optical sensor. The optical sensor uses an Optical Time Domain Reflectometer (OTDR) signal for sensing mechanical movement, and communicating the sensed movement to a remote location, such as a central office.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a first example of a fiber optic closure.

FIG. 2 is a view of the closure of FIG. 1 showing a cover removed from a base, and no internal components present.

FIG. 3 is a view of internal components of the closure of FIGS. 1 and 2 showing internal features and cabling extending to and from the closure.

FIG. 4 is a further view of the internal components of FIG. 3, showing an internal cover in an open position.

FIG. 5 is a perspective view of a second example of a fiber optic closure.

FIG. 6 is an exploded view of the closure of FIG. 5.

FIG. 7 is a view of the internal components of FIG. 5.

FIG. 8 shows one example of a sensor for detecting the status of a cover of a fiber optic closure.

FIG. 9 shows another example of a cover sensor for detecting the status of a cover of a fiber optic closure.

FIG. 10 shows another example of a cover sensor for detecting the status of a cover of a fiber optic closure.

FIG. 11 shows a first position of the cover of FIG. 10 relative to the cover sensor.

FIG. 12 shows a second position of the cover of FIG. 10 relative to the cover sensor.

FIG. 13 shows a tray sensor positioned relative to one tray of a set of internal rotatable trays in a fiber optic closure.

FIG. 14 shows the tray sensor of FIG. 13 and the monitored tray in a side view.

FIG. 15 shows the monitored tray of FIG. 14 in a rotated position to activate the tray sensor.

FIG. 16 shows a seal sensor for sensing the status of a gel seal in a fiber optic closure.

FIG. 17 shows two alternative spring elements useable with a position sensor to introduce an increased range of movement for the sensor.

FIG. 18 shows a different spring element used with a position sensor to introduce an increased range of movement for the sensor.

FIG. 19 shows a schematic arrangement of multiple closures relative to a central office including a sensor system for sensing the status of activity within a closure.

FIG. 20 shows a sectional schematic view of an optical sensor according to the present disclosure.

FIG. 21A shows a sectional schematic view of the optical sensor shown in FIG. 1 when an actuator is not compressed.

FIG. 21B shows a sectional schematic view of the optical sensor shown in FIG. 1 when the actuator is compressed.

FIG. 22 shows a perspective schematic view of an optical sensor according to a first exemplary embodiment of the present disclosure.

FIG. 23 shows a partially exploded schematic view of the optical sensor shown in FIG. 3.

FIG. 24 shows a perspective schematic view of the housing and main body frame of the optical sensor shown in FIG. 23.

FIG. 25 shows a perspective schematic view of the main body frame mounted in the housing in FIG. 24.

FIG. 26 shows a sectional schematic view vertically sectioned through the optical sensor shown in FIG. 22 along the central axis, with the actuator not compressed.

FIG. 27 shows a sectional schematic view horizontally sectioned through the optical sensor shown in FIG. 22 along the central axis, with the actuator not compressed.

FIG. 28A shows a schematic view of a monitoring device according to a first exemplary embodiment of the present disclosure.

FIG. 28B shows a curve diagram of light intensity acquired at an optical time domain reflectometer as a function of distance when the monitoring device shown in FIG. 28A operates.

FIG. 29A shows a schematic view of a monitoring device according to a fifth exemplary embodiment of the present disclosure.

FIG. 29B shows a curve diagram of light intensity acquired at an optical time domain reflectometer as a function of distance when the monitoring device shown in FIG. 29A operates.

FIG. 30 shows a schematic block diagram of a monitoring system for monitoring multiple monitored points by using the monitoring device according to the present disclosure.

FIG. 31 is a block diagram illustrating aspects of an example of a sensor system in accordance with the present disclosure.

FIG. 32 is a block diagram illustrating aspects of another example of a sensor system in accordance with the present disclosure.

FIG. 33 is a block diagram illustrating aspects of an example of a closure monitoring system in accordance with the present disclosure.

FIG. 34 is a chart illustrating example optical time-domain reflectometer signals of a monitoring system such as that shown in FIG. 33.

FIG. 35 is a block diagram illustrating aspects of another example of a sensor system in accordance with the present disclosure.

FIG. 36 is a chart illustrating example optical time-domain reflectometer signals of a sensor system such as that shown in FIG. 35.

FIG. 37 is a perspective view of another example fiber optic closure in which an optical sensor can be disposed.

FIG. 38A is a perspective view of a base of the fiber optic closure of FIG. 37 showing an example optical sensor disposed at a gel block of a cable anchoring and sealing arrangement of the fiber optic closure.

FIG. 38B is an exploded perspective view of a base of the fiber optic closure of FIG. 38A showing an example optical sensor disposed at a gel block of a cable anchoring and sealing arrangement of the fiber optic closure.

FIG. 39 shows the base, gel block, and optical sensor of FIG. 38 with a portion of the gel block removed for ease in viewing the optical sensor.

FIG. 40 shows the cable anchoring and sealing arrangement with pieces of the axially moving members exploded from a remainder of the cable anchoring and sealing arrangement.

FIG. 41 shows the cable anchoring and sealing arrangement assembled with the actuation part of the optical sensor extending into the gel block.

FIG. 42 is a cross-sectional view of a counterpart of the optical sensor in an exploded state.

FIG. 43 shows an exterior optical sensor that is disposed outside of the optical enclosure of FIG. 37 at an access opening of a handhole closure and that is connected to fibers extending into the optical enclosure.

FIG. 44A is a perspective view of another example fiber optic closure in which a fiber optic connection can be disposed.

FIG. 44B is a close-up perspective view of sealing arrangement mounting in which a fiber optic connection is disposed.

FIG. 45 is an exploded view of a sealing arrangement mounting in which a fiber optic connection is disposed.

FIG. 46 is a partially disassembled view of a sealing arrangement mounting in which a fiber optic connection is disposed.

FIG. 47A is a first perspective view of an axially movable member in which a fiber optic connection is disposed.

FIG. 47B is a second perspective view of an axially movable member in which a fiber optic connection is disposed.

FIG. 48 is an exploded view of a fiber optic adapter mounted within a bracket of an axially movable member.

FIG. 49 is a cross sectional view of a fiber optic adapter and non-ruggedized connector, in accordance with an embodiment of the disclosure.

FIG. 50 is a cross sectional view of a ruggedized connector, in accordance with an embodiment of the disclosure.

FIG. 51 is a cross sectional view of the fiber optic adapter and non-ruggedized connector of FIG. 49 coupled with the ruggedized connector of FIG. 50, in accordance with an embodiment of the disclosure.

FIG. 52 is a perspective view of a bracket to facilitate installing smaller cables through a cable pass through location of a sealing arrangement, in accordance with an embodiment of the disclosure.

### DETAILED DESCRIPTION

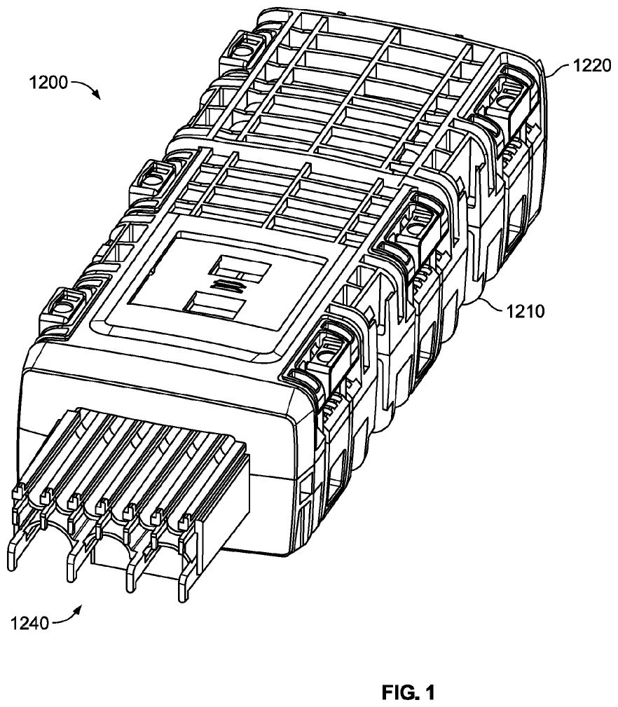

Referring now to FIGS. 1-4, a first and second type of closure 1200 is shown including a base 1210, a cover 1220, and a cable seal region 1240. Within the first closure 1200, various conductivity components are provided for connecting incoming and outgoing cables. In the examples shown, an internal cover 1250 is positioned over a plurality of rotatable trays 1260 for containing fiber slack and splices. A sensor can be provided for detecting whether the cover 1220 is removed from the base 1210. A sensor can be provided for whether the gel seal 1240 associated with incoming and outgoing cables has been activated. A sensor can be provided to detect whether the internal cover 1250 has been removed relative to a remainder of interior components. A sensor can be provided for detecting whether one or more of the rotatable trays 1260 have been moved.

The sensors usable in first closure 1200 can be optical sensors using an OTDR signal for sensing mechanical movement, and communicating the sensed movement to a remote location, such as a central office, through one of feeder cables 1270. This feeder cable may or may not also carry data signals.

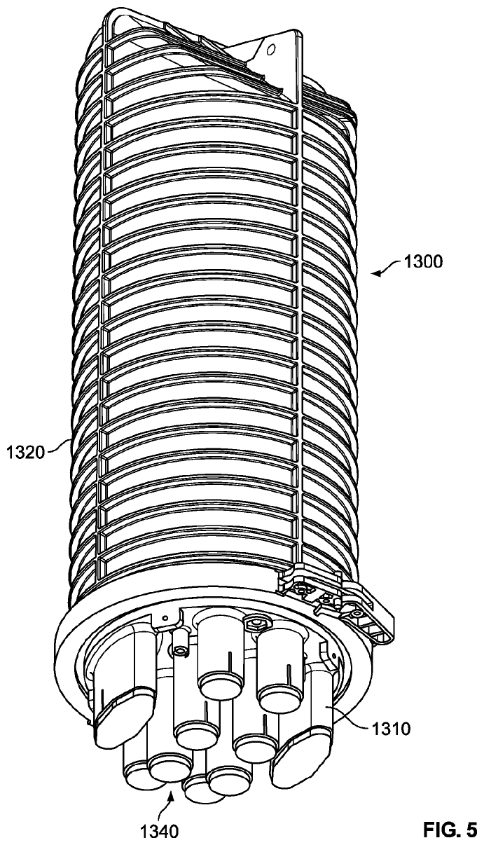

Referring now to FIGS. 5-7, a different type of closure 1300 is provided having a base 1310, a dome cover 1320, and a cable seal region 1340. Incoming and outgoing cables are provided. A sensor can be used for detecting whether the cover 1320 has been removed from the base 1310. A sensor can also be provided to detect whether any of the rotatable trays 1360 have been moved.

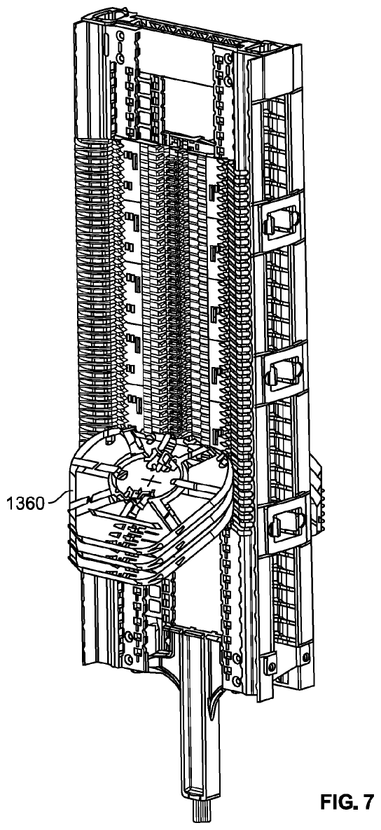

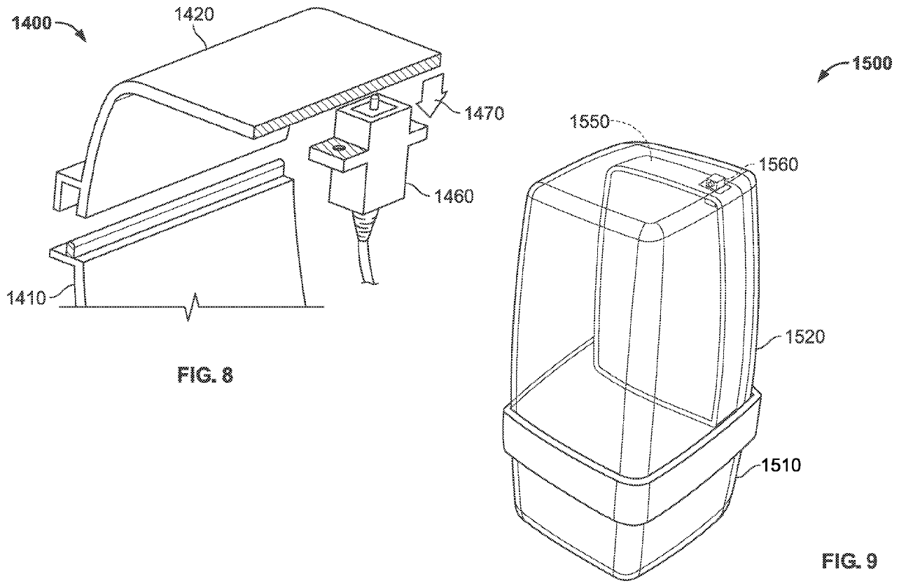

Referring now to FIG. 8, a closure 1400 is shown similar to the closure 1200 of FIGS. 1-4. A sensor 1460 is provided to detect whether the cover 1420 has been removed relative to the base 1410. Sensor 1460 can be factory installed or field installed.

Referring now to FIG. 9, a closure 1500 similar to the closure 1300 of FIGS. 5-7 is shown with a sensor 1560 to detect whether a dome cover 1520 has been removed relative to a base 1510. Sensor 1560 can be mounted to internal frame 1550 of the closure 1500 that hold rotating trays, like trays 1360.

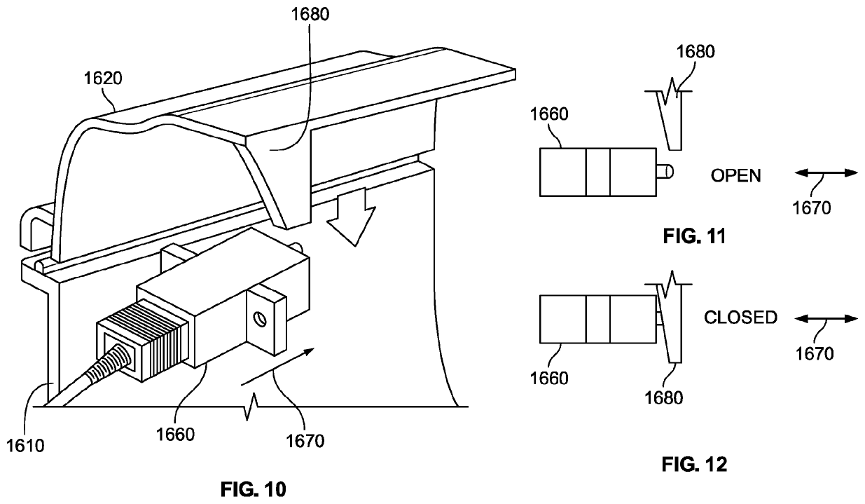

In FIGS. 10-12, a sensor 1660 is positioned in an alternative arrangement relative to the arrangement of FIG. 8 for detecting whether a cover 1620 has been moved relative to a base 1610. In particular, the sensor 1460 of FIG. 8 is shown axially aligned with cover 1420 that is moved along the sensor axis 1470. In FIGS. 10-12, the sensor 1660 is positioned substantially orthogonal to the sensor axis 1670. An angled activation tab 1680 on the cover 1620 is positioned to move the sensor 1660 to indicate whether the cover 1620 has been moved relative to the base 1610.

In FIGS. 13-15, a sensor 1760 is positioned on one of the rotatable trays 1770. If the top tray 1772 is rotated, the sensor 1760 is activated to indicate relative rotation of the tray and a tray mount 1780.

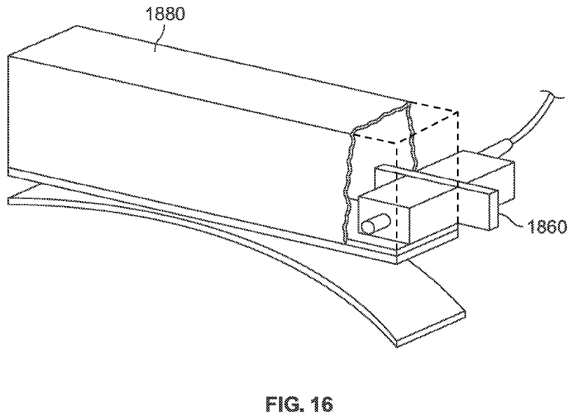

FIG. 16 shows a sensor 1860 positioned to detect whether a gel seal 1880 positioned between two components of a closure (for example, a cover and a base, or a port seal) has been activated/triggered or de-activated/untriggered. The sensor 1860 responds to movement of the gel seal 1880 as the seal is compressed to a sealed state between positions as the status of the gel seal goes between activated and deactivated.

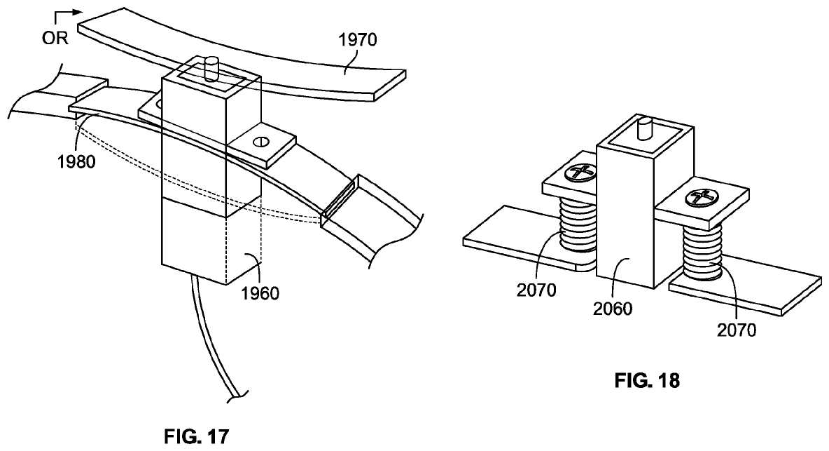

FIG. 17 shows a sensor 1960 including a spring feature for adding tolerance to the sensor 1960 such that the range of operation of the sensor 1960 is increased. Either or both a leaf springs 1970, 1980 can be added to increase tolerances of sensor 1960. FIG. 18 shows an alternative arrangement for a sensor 2060 including a spring feature to increase the range of operation of the sensor. Coil springs 2070 can be added to increase tolerances of sensor 2060.

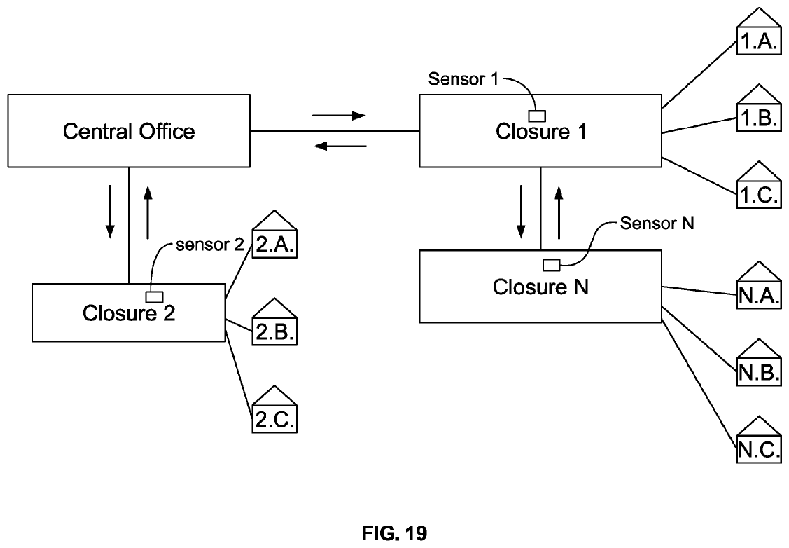

FIG. 19 shows signal communication between a central office and various closures in the system wherein a change in status of a closure (e.g., one of the closures depicted in FIG. 1018) is communicated to the central office, such as through an OTDR signal. The various sensors (e.g., sensors 1460, 1560, 1660, 1760, 1860, 1960, or 2060, as depicted in FIGS. 1-18) can be factory installed or field installed. The sensors can be moved over time to detect movement of different aspects, such as different trays.

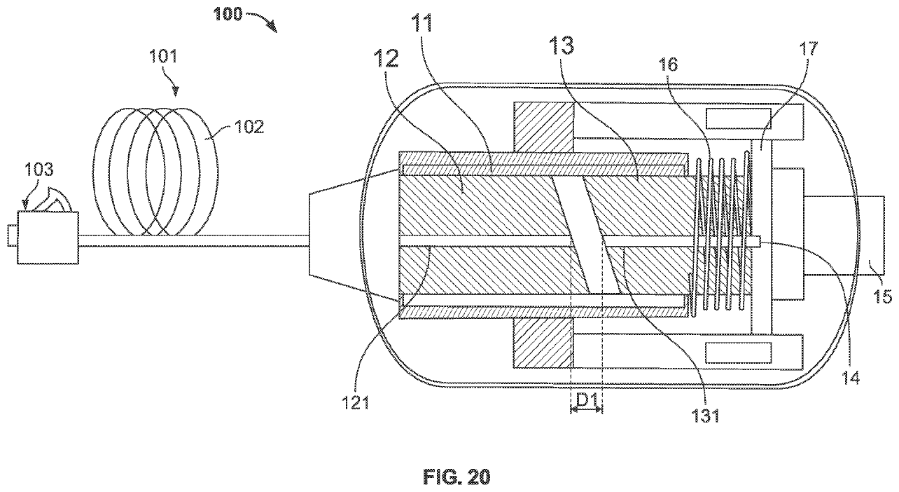

In FIGS. 20-36, example sensors are shown which detect relative movement between components. U.S. Pat. Nos. 9,741,229, 9,892,614, 10,034,546, and 10,694,850 concern optical sensors and monitoring devices, the disclosures of which are hereby incorporated by reference. Other sensors and communications systems can be used including NB-LTE radio-access technology. Another technology that can be used is the LoRaWAN-Low Power, Wide Area (LPWA) networking protocol which wirelessly connect battery operated sensors to the internet in the networks.

FIG. 20 shows a sectional schematic view of an optical sensor 100 according to the present disclosure. According to the present disclosure, the optical sensor 100 can include a holding sleeve 11, a fixed ferrule 12 for optically coupling with an optical fiber of an optical cable and fixedly mounted in the holding sleeve 11, a movable ferrule 13 movably mounted in the holding sleeve 11 at a predetermined distance D1 existing between a first movable end of the movable ferrule 13 and a first fixed end of the fixed ferrule 12 in the holding sleeve 11, a reflection part 14 arranged at a second movable end of said movable ferrule 13 opposite to said first movable end, for reflecting light entering the movable ferrule 13, and an actuation part 15, said actuation part 15 being constructed to drive the movable ferrule 13 to move so that the first movable end of the movable ferrule 13 comes into contact with the first fixed end of the fixed ferrule 12, so as to allow an optical fiber hole 121 of the fixed ferrule 12 to contact with an optical fiber hole 131 of the movable ferrule 13.

The optical sensor 100 further comprises a reset device 16, said reset device 16 being arranged between the movable ferrule 13 and the actuation part 15, and when the actuation part 15 contracts towards the interior of the optical sensor 100 due to a pressure being applied, the actuation part 15 drives the movable ferrule 13 to move against the force of the reset device 16. The reset device 16 can be a spring surrounding the movable ferrule 13, and can also be a reset device whose movement is based on magnetic force or another device capable of automatically driving the actuation part to reset.

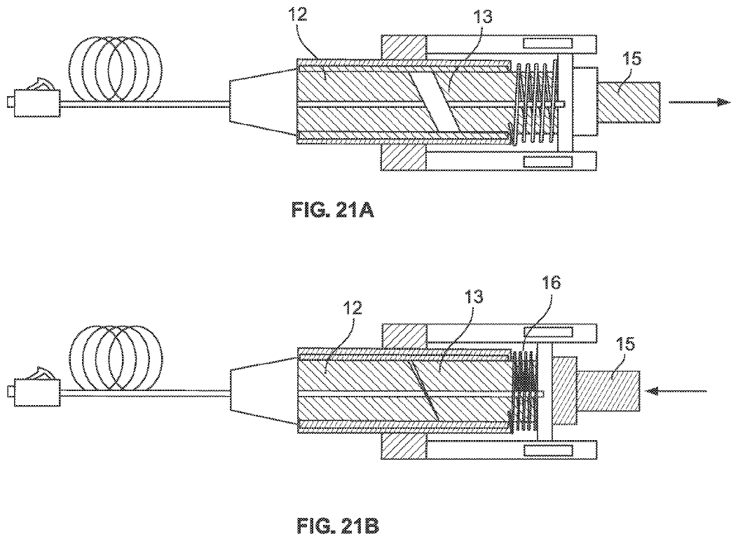

Generally, as shown in FIG. 21A, when the actuation part 15 is in an uncompressed state, due to the action of the reset device 16, a predetermined distance D1 is kept between the first movable end of the movable ferrule 13 and the first fixed end of the fixed ferrule 12 in the holding sleeve 11, so that a beam of light from the fixed ferrule 12 will freely diverge at the first fixed end while only a very small part of the beam can be incident to the movable ferrule and reflected back to the fixed ferrule by the reflection part 14.

On the other hand, as shown in FIG. 21B, when the actuation part 15 is compressed, the actuation part 15 overcomes the acting force of the reset device 16 and drives the movable ferrule 13 to move towards the fixed ferrule 12, so that the first movable end of the movable ferrule 13 comes into contact with the first fixed end of the fixed ferrule 12, so as to allow the optical fiber hole 121 of the fixed ferrule 12 to contact with the optical fiber hole 131 of the movable ferrule 13. Thus, most of the beam from the fixed ferrule 12 will be incident to the movable ferrule and reflected back to the fixed ferrule 12 by the reflection part 14. The reflected beam can be transmitted to an optical time domain reflectometer through an optical cable transmission device, so as to detect the condition where the actuation part 15 is driven (which will be described in detail

According to the optical sensor 100 of the present disclosure, the reflection part 14 can be a flat reflection face formed on the second movable end of the movable ferrule 13, such as by grinding, polishing treatment, film coating, attaching a reflector mirror and the like, for reflecting the beam incident to the movable ferrule 13 and emitting a reflected beam from the movable ferrule 13. In one embodiment, the reflection face can provide a reflection characteristic independent of wavelength. In another embodiment, the reflection face can also provide a selective waveband reflection characteristic dependent on wavelength. In an alternative embodiment, the reflection part 14 is a smooth and flat reflection face formed on the actuation part 15 and in sealed connection with the second movable end of the movable ferrule 13, and thus can also reflect a beam incident to the movable ferrule 13 and emit a reflected beam from the movable ferrule 13.

Furthermore, a limiting part 17 is arranged on the movable ferrule 13, the limiting part 17 being constructed to limit the distance of movement of said movable ferrule 13. The limiting part 17 can be used to prevent the movable ferrule 13 from excessively pressing the fixed ferrule 12 when the actuation part 15 contracts, and from separating from the optical sensor 100 when the actuation part 15 extends due to the action of the reset device 16. Alternatively, the limiting part can also be arranged on the actuation part 15.

According to the optical sensor 100 of the present disclosure, the end surfaces of the first fixed end of the fixed ferrule 12 and of the first movable end of the movable ferrule 13 are constructed to be parallel with each other and form an angle relative to the axis of the holding sleeve 11. Preferably, the end surfaces of the first fixed end and the first movable end are inclined by an angle of between about 5° to about 10° (e.g., 8°, etc.), relative to the axis of the holding sleeve 11. This inclined structure facilitates a tight contact between the end surfaces of the first fixed end and the first movable end, and minimizes light loss when a beam is transmitted between the fixed ferrule 12 and the movable ferrule 13. However, the present disclosure is not limited to such an inclined end surface, and those skilled in the art can understand that the inclination of the end surfaces of the first fixed end and first movable end relative to the axis of the holding sleeve 11 can be set to be perpendicular, or they have curved surface structures complementary to each other, as long as a beam is maximally transmitted between the fixed ferrule and movable ferrule after they are in contact.

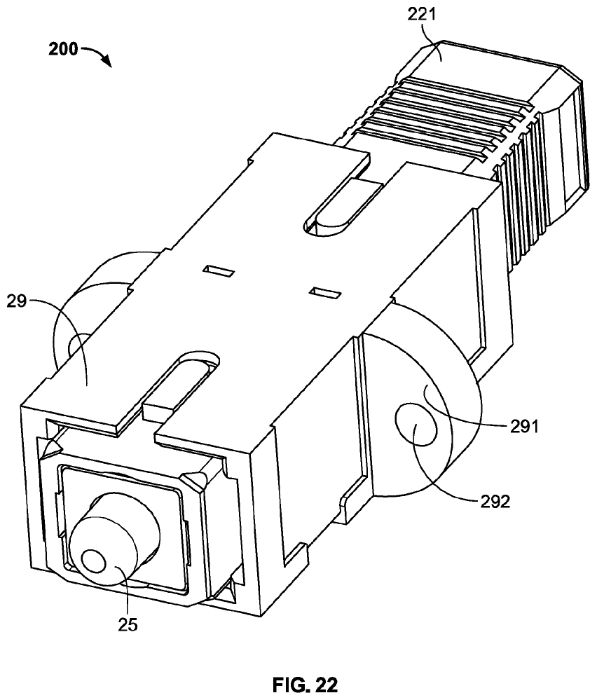

FIGS. 22-27 show an optical sensor 200 according to an embodiment of the present disclosure, the optical sensor 200 having the same basic structure as the optical sensor 100. Particularly, referring to FIGS. 22-27, the optical sensor 200 can include a holding sleeve 21, a fixed ferrule 22 for optically coupling with an optical fiber of an optical cable and fixedly mounted in the holding sleeve 21, a movable ferrule 23 movably mounted in the holding sleeve 21 a predetermined distance D2 existing between a first movable end of said movable ferrule 23 and a first fixed end of the fixed ferrule 22 in the holding sleeve 21, a reflection part 24 arranged at a second movable end of said movable ferrule 23 opposite to said first movable end, for reflecting light entering the movable ferrule 23, and an actuation part 25, said actuation part 25 being constructed to drive the movable ferrule 23 to move so that the first movable end of the movable ferrule 23 comes into contact with the first fixed end of the fixed ferrule 22. The optical sensor 200 further includes a reset device 26, said reset device 26 being arranged between the holding sleeve 21 and the actuation part 25, and when the actuation part 25 contracts towards the interior of the optical sensor 200 due to a pressure being applied, the actuation part 25 drives the movable ferrule 23 to move against the force of the reset device 26.

The optical sensor 200 further includes a main body frame 27 and a guide frame 28. The holding sleeve 21 is fixedly arranged in the main body frame 27, the guide frame 28 is mounted on the main body frame 27, and the actuation part 25 is movably mounted on the guide frame 28. Particularly, the actuation part 25 passes through a through hole 282 formed on an end part 281 of the guide frame 28, and a protruding limiting part 251 arranged on the actuation part 25 is arranged on the inner side of the end part 281, so as to prevent the actuation part 25 from moving completely out of the guide frame 28, the limiting part 251 is provided with a guide protrusion 252, and said guide frame 28 is provided with a guide groove 283 matching the guide protrusion 252. As such, with the cooperation of the guide protrusion 252 and guide groove 283, the actuation part 25 pushes the movable ferrule 23 to move axially and rotation of the actuation part 25 and the movable ferrule 23 is prevented.

The optical sensor 200 further includes a housing 29, the main body frame 27 being mounted in the housing 29. Referring to FIGS. 25-27, the main body frame 27 can include a base part 271 mounted on the housing 29, a sleeve holder 272 extending from the base part 271, the holding sleeve 21 being held in the sleeve holder 272, and two opposite extension arms 273, the sleeve holder 272 being arranged between the two extension arms 273. An engagement protrusion 274 protruding inwards is formed on a free end of the extension arm 273 and, correspondingly, an engagement groove 284 is formed on the guide frame 28. After a spring as the reset device 26 is sheathed on the movable ferrule 23 and the actuation part 25 is allowed to extend out of the interior of the guide frame 28 via the through hole 282, the guide frame 28 can be inserted into the housing 29 and the engagement protrusion 274 is engaged with the engagement groove 284, so as to hold the guide frame 28 in the housing 29. A positioning frame 285 can be further mounted between the housing 29 and the guide frame 28, to stably mount the guide frame 28 inside the housing 29. It can be understood that the positioning frame 285 can also be omitted and some positions on the guide frame 28 are constructed to be in direct contact with the interior of the housing 29, so that the guide frame 28 can also be held inside the housing 29. Furthermore, a mounting part 291 is arranged on the outside of the housing 29, and a mounting hole 292 is arranged on the mounting part 291. As such, the optical sensor 200 can be mounted onto a monitored object such as a closure arranged in the field, using a bolt structure.

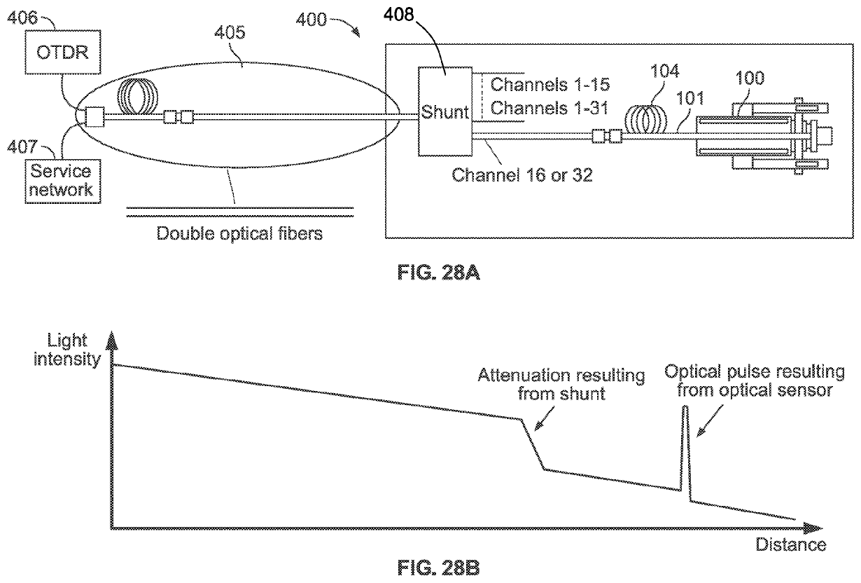

FIGS. 28A-36 show implementation of the example sensors for passively detecting relative movement of two components. According to an embodiment of a still further aspect of the present disclosure, a monitoring device is provided which includes at least one optical sensor assembly as described in the embodiments above and an OTDR (optical time domain reflectometer). The optical sensors of the optical sensor assembly are respectively mounted to at least one monitored object, such as a closure. The optical time domain reflectometer is constructed to emit a main beam towards said optical sensors through the optical cable transmission device of the optical sensor assembly and receive a reflected beam reflected from said optical sensors, and the optical path distances between the optical time domain reflectometer and the optical sensors are different from one another.

FIG. 28A shows a schematic view of a monitoring device 400 according to an exemplary embodiment of the present disclosure. The monitoring device 400 comprises an optical sensor assembly and an optical time domain reflectometer 406. The optical sensor assembly comprises the optical sensors 100, 200 and 300 according to the present disclosure and an optical cable transmission device. The optical sensor 100 is mounted to a closure, and the optical sensor is configured such that the actuation part 15 of the optical sensor is pressed when a cover of the closure is closed (or opened), so as to result in movement of the movable ferrule towards the fixed ferrule. The optical time domain reflectometer 406 emits a main beam towards the optical sensor 100 through the optical cable transmission device 101 and receives a reflected beam reflected from the optical sensor 100.

The monitoring device 400 of the first embodiment further comprises a shunt 408, which is constructed to split a detection beam out of the main beam from the optical time domain reflectometer 406, the detection beam being transmitted to an optical sensor assembly. More specifically, the optical time domain reflectometer 406 is optically connected with the shunt 408 through a main optical cable transmission device 405. Furthermore, the main optical cable transmission device 405 comprises two optical fibers, of which one optical fiber is connected with the optical time domain reflectometer 406 and the other optical fiber is connected with a service network 407 to transmit communication information to the closure. Examples of the shunt can include a PLC shunt, a circulator, or an equivalent shunt device. The shunt 408 comprises multiple optical channels, such as 16 or 32 optical channels, wherein one optical channel 16 or optical channel 32 is connected with the optical cable transmission device 101 connected to an optical sensor 100, for transmitting a detection beam and a reflected beam reflected from the optical sensor 100 while the other optical channels 1-15 or 1-31 are used for transmitting other optical information signals.

The intensity of the reflected beam can be acquired at the optical time domain reflectometer 406. FIG. 28B shows a curve diagram of the light intensity acquired at an optical time domain reflectometer as a function of distance when the monitoring device shown in FIG. 28A operates. As shown in FIG. 28B, in the process of transmitting a beam in the optical fiber and the shunt, the light intensity acquired at the optical time domain reflectometer 406 decreases with the length of the optical fiber (i.e., the distance between the optical sensor and the optical time domain reflectometer) or decreases due to passing through a high attenuation device such as the shunt.

When the cover of the closure is closed, the actuation part 15 of the optical sensor 100 is pressed, resulting in a movement of the movable ferrule 13 so that the first movable end of the movable ferrule 13 comes into contact with the first fixed end of the fixed ferrule 12 and, when the optical fiber hole 121 of the fixed ferrule 12 contacts with the optical fiber hole 131 of the movable ferrule 13, most of the detection beam from the fixed ferrule 12 is incident to the movable ferrule 13 and reflected back to the fixed ferrule 12 by the reflection part 14. The reflected beam is further transmitted to the optical time domain reflectometer 406 and therefore the light intensity acquired by the optical time domain reflectometer 406 shows a pulsed jump. The optical time domain reflectometer 406 further converts the change in light intensity into a change in electric signal, so as to detect the closure of the cover of the closure according to the change in electric signal.

Although an exemplary embodiment, in which an optical pulse can be acquired at the optical time domain reflectometer when the closure is closed, has been described as above, the present disclosure is not limited thereto. Those skilled in the art understand that the optical sensor can be mounted such that the actuation part 15 is driven when the cover of the closure is opened, to drive the movable ferrule 13 to move towards the fixed ferrule, so that the generation of an optical pulse signal is detected at the optical time domain reflectometer 406, so as to determine that the cover of the closure has been opened. In a further alternative embodiment, when the optical sensor is mounted such that when the cover is opened, the actuation part 15 drives the movable ferrule 13 to move away from the fixed ferrule due to the acting force of the reset device, a decreased or disappearing optical pulse signal is detected at the optical time domain reflectometer 406, so as to determine that the cover of the closure has been opened. It can be understood that the degree of opening of the cover of the closure can be determined by using the change in intensity of the optical pulse signal detected at the optical time domain reflectometer 406.

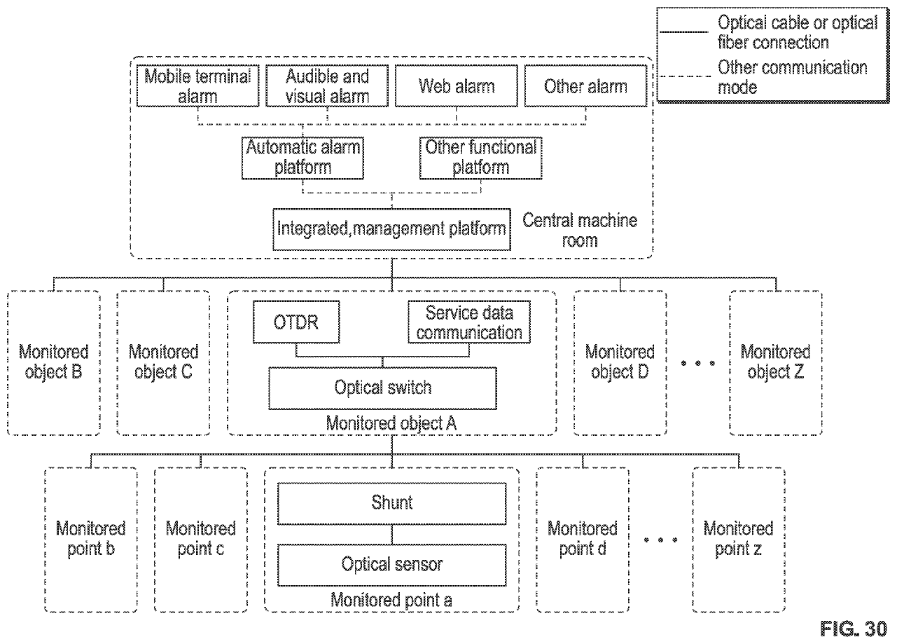

As shown in FIG. 30, an integrated management platform arranged in a central machine room can monitor in real time the opening or closing of the cover of the closure. If the cover of the closure is opened not for a normal reason, for example opened accidentally, or opened due to technical personnel or engineering personnel forgetting to close it, or opened due to being impacted or stolen, the integrated management platform activates an automatic alarm platform to send an alarm signal, for example, by using a mobile terminal alarm, audible and visual alarm, web alarm, or other types of alarms which can be sensed by related personnel.

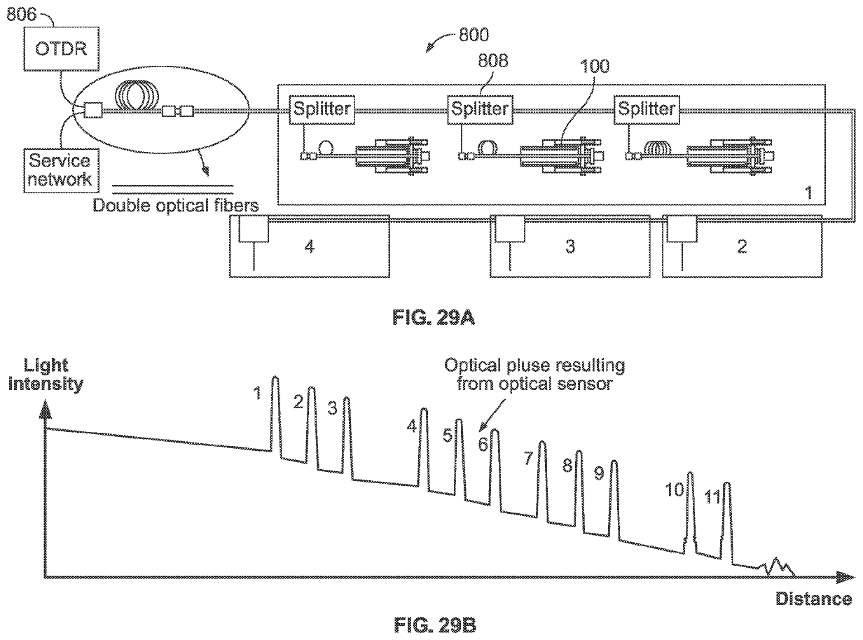

FIG. 29A shows a schematic view of a monitoring device 800 according to another exemplary embodiment of the present disclosure. The monitoring device 800 comprises at least multiple optical sensor assemblies as described in the embodiments above and an optical time domain reflectometer. The optical sensors of the optical sensor assemblies are respectively mounted to at least one monitored object, such as a closure. The monitored objects are divided into multiple groups: for example, each group of monitored objects is arranged in one region, and at least one optical sensor assembly is arranged for each group of monitored objects.

The monitoring device 800 further comprises multiple splitters 808 connected in series, each splitter 808 splits a detection beam from a previous stage into a main detection beam and a detection sub-beam, and each splitter 808 is arranged in a propagation path of the detection main beam and each optical sensor 101 receives the corresponding detection sub-beam. Furthermore, the light flux ratio of the main detection beam and detection sub-beam output from each splitter 808 is in a range of between about 20:80 and about 1:99.

FIG. 29B shows a curve diagram of light intensity acquired at an optical time domain reflectometer as a function of distance when the monitoring device 800 shown in FIG. 29A operates. As shown in FIG. 29B, the light intensity acquired by the optical time domain reflectometer 806 shows multiple pulse jumps, each pulse corresponding to one optical sensor. The optical time domain reflectometer 806 further converts the change in light intensity into a change in electric signal, so as to detect the opening of the cover of the corresponding closure according to the change in electric signal.

FIG. 30 shows a schematic block diagram of a monitoring system for monitoring multiple monitored points using the monitoring device of the present disclosure. As shown in FIG. 30, the mechanical state of one monitored object (such as monitored objects A-Z), multiple monitored points of one monitored object (such as monitored points A-Z of monitored object A), or multiple groups of monitored objects can be monitored using the monitoring device of the present disclosure based on optical sensors.

Referring now additionally to FIGS. 31-36, this disclosure relates to remote monitoring of passive optical network elements, based on the reflected power at certain discrete points along an optical fiber. FIG. 31 illustrates an example of a sensor system in accordance with aspects of the present disclosure. The illustrated sensor system 1010 includes a sensor 1012 coupled to an optical fiber 1014 and a reflector 1016. The reflector 1016 is configured to provide a reflected optical signal. Power can be reflected by metal coated fibers, Thin Film Filters (TFF) or Bragg grating devices, for example.

In certain embodiments of the illustrated sensor system 1010, the sensor 1012 is situated in a closure 1100. The reflected power is intensity modulated in response to a parameter 1018 associated with the closure 1100, such as moisture in the closure, closure temperature, intrusion into the closure, etc. These modulated reflections can be detected with a conventional optical time-domain reflectometer (OTDR). An OTDR is an optoelectronic instrument used to characterize an optical fiber. Optical pulses are injected into an end of the optical fiber 1014, and light reflected back from points along the fiber 1014 is extracted from the same end of the fiber 1014 and analyzed. The strength of the return pulses is measured as a function of time, and is plotted as a function of fiber length. Embodiments of the disclosed sensor system provide a fully passive optical sensor system (no electricity or battery required at the monitored closure).

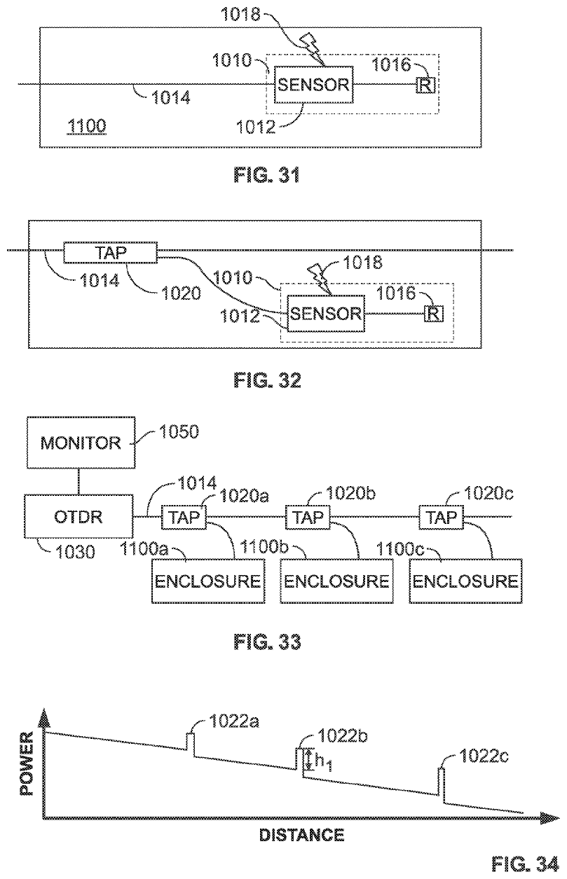

In the example of FIG. 31, a dedicated optical fiber 1014 is provided for monitoring parameters of the closure 1100. FIG. 32 illustrates an example that includes a fiber optic tap 1020 that provides a connection to the sensor 1012. In some implementations, a multiplexing scheme, such as wavelength division multiplexing (WDM), is used to allow the same fiber 1014 to be used both for monitoring and for communications.

FIG. 33 illustrates an implementation where three tap couplers 1020 are coupled to the fiber 1014 to connect to three sensors in respective closures 1100a, 1100b, 1100c. The optical fiber 1014 is coupled to an OTDR 1030 that receives light reflected from the reflectors 1016 associated with the sensors 1012 for each of the closures 1100a, 1100b, 1100c. FIG. 34 illustrates an example of the return pulses plotted as a function of distance, thus providing a pulse 1022a, 1022b, 1022c corresponding to each of the closures 1100a, 1100b, 1100c.

The OTDR may further be connected to a monitoring system 1050 that provides information regarding the monitored closures, alarms, data logging, etc. The monitoring system 1050 could be implemented by any suitable computing system. In some examples, the monitoring system 1050 includes an appropriately programmed processor configured to execute various processes for analyzing the OTDR signals. A system memory stores an operating system for controlling the operation of the monitoring system.

The system memory is computer-readable media. Examples of computer-readable media include computer storage media and communication media. Computer storage media is physical media that is distinguished from communication media. Computer storage media includes physical volatile and nonvolatile, removable and non-removable media implemented in any method or technology for persistent storage of information, such as computer-readable instructions, data structures, program modules, or other data. Computer storage media also includes, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to persistently store desired information and which can be accessed by the monitoring system 1050. Any such computer storage media may be part of or external to the monitoring system 1050.

Communication media is typically embodied by computer-readable instructions, data structures, program modules, or other data, in a modulated data signal, such as a carrier wave or other transport mechanism, and includes any information delivery media. The term “modulated data signal” means a signal that has one or more of its characteristics set or changed in such a manner as to encode information in the signal. By way of example, communication media includes wired media such as a wired network or direct-wired connection, and wireless media such as acoustic, RF, infrared and other wireless media.

The monitoring system 1050 may further include one or more input and output devices, such as a keyboard, mouse, a display, etc. The monitoring system 1050 can be connected to the OTDR 1030 and other computing devices via a network that provides a data communication path for data transfer between the OTDR 1030 and the monitoring system 1050.

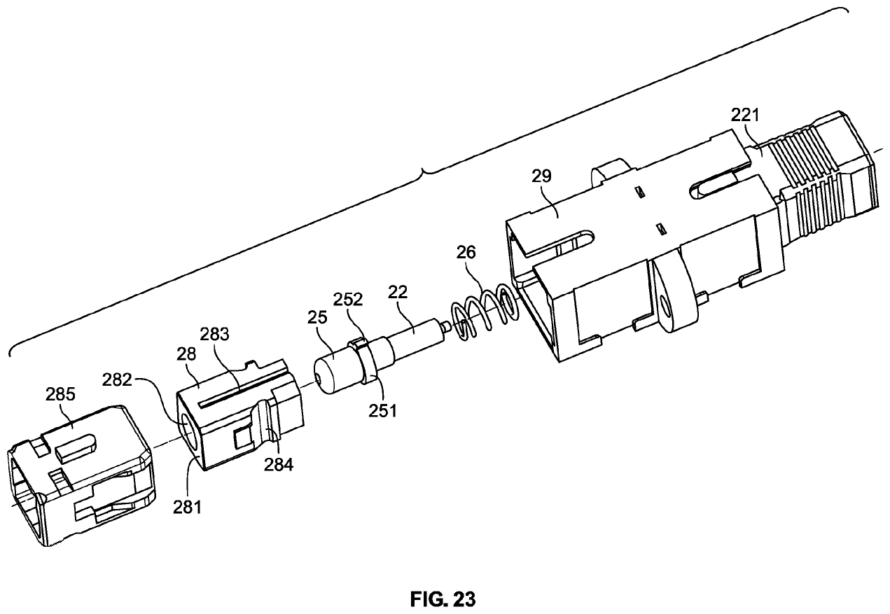

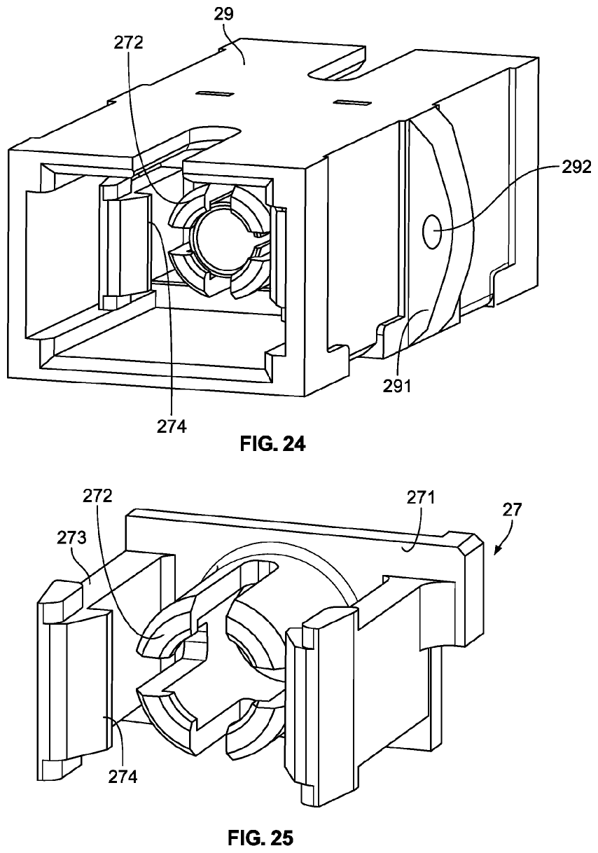

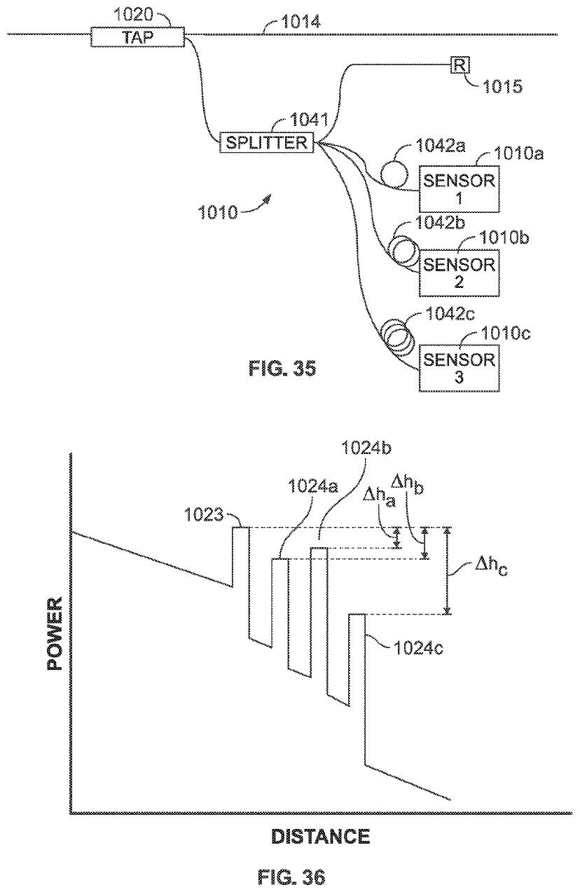

FIG. 35 illustrates another example where a plurality of parameters (cover, tray, temperature, water, humidity, intrusion) can be monitored for the same closure 1100 or at a single location using a single optical fiber 1014. A fiber optic tap 1020 is coupled to an optical fiber 1014 and to a 1:4 splitter 1041, which is connected to a plurality of sensor systems 1010a, 1010b, 1010c. As disclosed above, each of the sensor systems 1010 includes sensor parts 1012 and a corresponding first reflector 1016 as shown, for example, in FIGS. 23 and 24. Each of the sensors 1010a, 1010b, 1010c is connected to the splitter 1040 via a corresponding time delay device such as delay loops 1042a, 1042b, 1042c, with each delay loop having a different length to delay the OTDR signal a different time period for each reflected signal. The second reflector 1016 is further coupled to the splitter 1040 to provide a reference signal. In some implementations, each sensor monitors a different parameter 1018a, 1018b, 1018c. A comparison of the reflected optical signals from each of the sensors 1010a, 1010b, 1010c to the second optical signal from the reference reflector 1017 provides an indication of the plurality of monitored parameters.

For example, the sensor system 1010 could monitor three movable aspects of a single closure, or a variety of other parameters such as humidity, intrusion and temperature for a single closure. Humidity or moisture sensors could be formulated using a material that swells or expands in response to moisture. As the material swells, it presses an optical fiber in a “sawtooth” cavity or a cavity with radiused curves. A temperature sensor can be formed using a bi-metal structure that similarly deforms s fiber in response to temperature variation.

FIG. 36 illustrates examples of various OTDR signals generated by the system shown in FIG. 35. The pulse 1023 is the reference pulse from the reflector 1017, and the other three pulses 1024a, 1024b, 1024c correspond to the signals reflected from the reflectors associated with the sensors 1010a, 1010b, 1010c. As noted above, each of the sensors 1010a, 1010b, 1010c is coupled to the splitter 1040 via a respective delay loop 1042a, 1042b, 1042c, so the OTDR pulses associated with the respective sensors are spaced along the distance axis. Comparing each of the sensor pulses 1024a, 1024b, 1024c to the reference pulse 1023 results in a corresponding Δh signal, Δha, Δhb, Δhc. When the monitored parameter 1018 changes, it results in the respective sensor attenuating the reflected signal, which in turn changes the pulse height as compared to the reference pulse 1023.

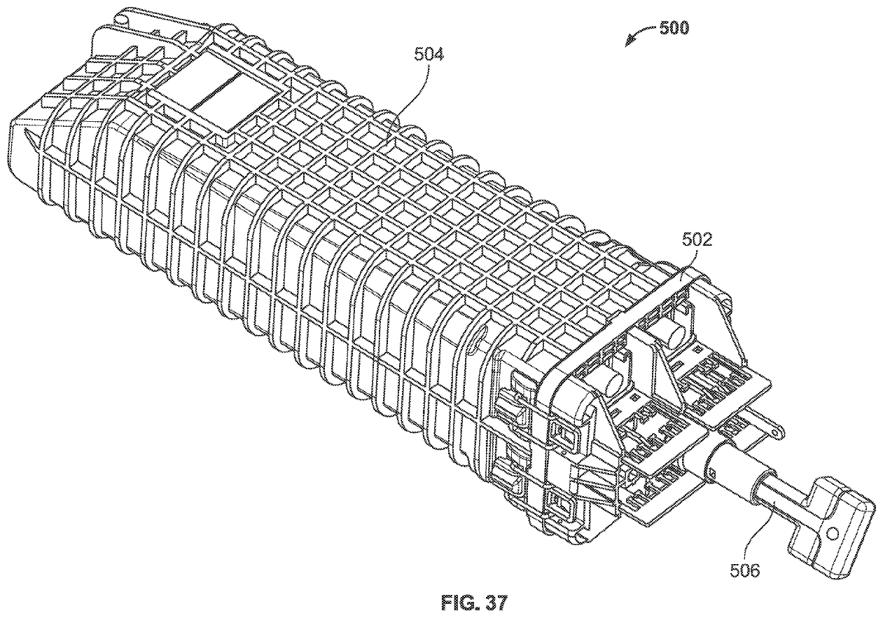

FIG. 37-43 illustrate another example closure 500 in which an optical sensor 520 is disposed. The closure 500 includes a base 502 to which a cable anchoring and sealing arrangement 510 is mounted. The closure 500 also includes a cover 504 (e.g., a dome style cover) that mounts to the base 502 to enclose the cable anchoring and sealing arrangement 510 within an interior of the closure 500.

The cable anchoring and sealing arrangement 510 which can include pressurization structures (e.g., walls, plates, parts, components, elements, structures, etc.) between which sealant can be axially contained and pressurized. In certain examples, the sealing arrangement 510 can include one or more parts, including a gel block 512 of gel or other sealant disposed between first and second axially movable members 514, 516 (e.g., pressure plates). In certain examples, the sealing arrangement 510 can include a frame structure and sealant containment walls coupled to the frame structure. The sealant containment walls can be integrated as part of sealing modules and can function to provide containment of sealant of the sealing modules. At least one of the axially movable members 514, 516 is attached to an actuator system 506 that extends outwardly from the base 502, so that the actuator system 506 is accessible from an exterior of the closure 500. For example, in one embodiment, the actuator system 506 can include a spring for biasing the pressurization structures together to pressurize the sealant.

In one embodiment, the closure 500 includes a sealing arrangement 510 that mounts within an opening for sealing about one or more cables desired to be routed into an interior of the closure 500 through one or more openings. The sealing arrangement 510 can be configured to provide peripheral sealing of the closure 500 about a perimeter located between the base 502 and the cover 504. In the example shown, the closure 500 includes a cover 504 (e.g., a dome style cover) defining an opening at one end, and a base 502 that mounts to the end of the cover 504. In certain examples, the base 502 can be detachably secured to the cover 504 by a mechanical fastening arrangement that can include latches, clamps, fasteners, or the like. The sealing arrangement 510 can be retained in the opening by the base 502. In some embodiments, a frame supporting fiber-optic components (e.g., optical splice trays, optical splitter trays, etc.) can be at least partially contained within the closure 500.

In one example, the sealing arrangement 510 includes a volume of sealant that may be formed by one or more sections or blocks of sealant (e.g., gel blocks 512) defining a plurality of cable pass through locations (e.g., ports, interfaces between adjacent sections of sealant, etc.). When pressurized, the gel blocks 512 are configured for providing seals about structures (e.g., cables, plugs, etc.) routed through the pass through locations of the gel blocks 512 and are also configured for providing a peripheral seal between the base 502 and the cover 504 about a boundary (e.g., perimeter, profile, etc.) of the opening of the cover 504.

In one example, the actuator system 506 includes inner and outer pressurization structures 517, 518 between which the gel blocks 512 are pressurized. The actuator system 506 can include a threaded drive system that drives relative movement of the pressurization structures 517, 518 to pressurize the gel blocks 512. Torque for driving the threaded drive system can be provided by a torque application interface such as a handle 507. A spring can be incorporated into the actuation arrangement for applying a pressurization load. Example actuator arrangements are disclosed by PCT International Publication No. WO2014/005916, which is hereby incorporated by reference in its entirety.

The sealant of the gel blocks 512 is pressurized between the inner and outer sealant pressurization structure 517, 518 when the inner and outer pressurization structures 517, 518 are forced toward each other by rotating the handle 507 in a first rotational direction and the sealant of the gel blocks 512 is de-pressurized when the inner and outer pressurization structures 517, 518 are moved away from each other by rotating the handle 507 in a second rotational direction opposite form the first rotational direction. As used herein an axial direction or orientation is in an orientation along an axis 511 of the actuator arrangement.

The gel blocks 512 are provided as part of sealing arrangement 510 that removably mount between the inner and outer pressurization structures 517, 518. The sealing arrangements 510 each include a volume of sealant (e.g., gel block 512, etc.) positioned axially between axially movable members 514, 516. Accordingly, when in the actuated position, the axially movable members 514, 516 apply a compressive load to the gel block 512, such that the gel block 512 expands radially outwardly to seal against the cover 504 when compressed. In certain examples, the gel block 512 expands radially inwardly to seal against cables routed through the gel block 512 when compressed.

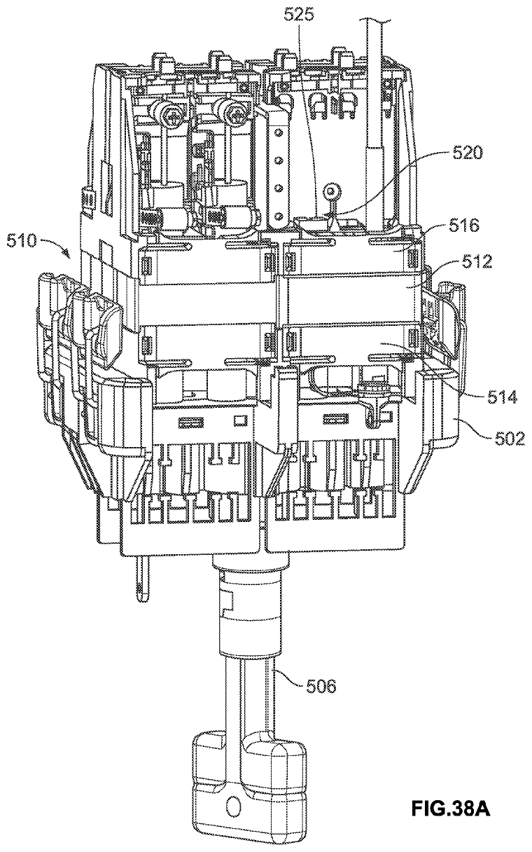

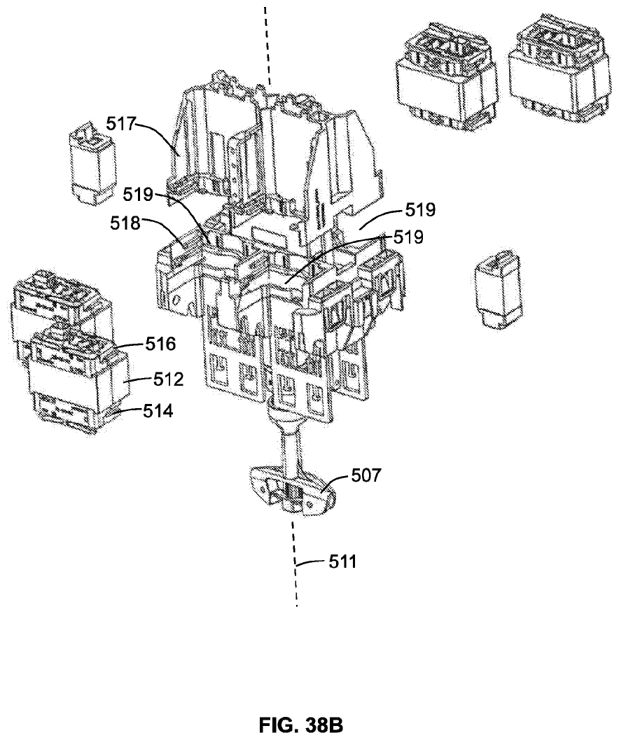

As depicted in FIG. 38B, the sealing arrangements 510 are insertable into and removeable from mounting locations 519 defined by inner and outer sealant pressurization structure 517, 518. The sealing arrangements 510 are insertable into the mounting locations 519 in laterally inward insertion directions and are removeable from the mounting locations 519 in laterally outward removable directions. In some embodiments, the insertion and removal directions are substantially orthogonal with respect to the axial direction of the closure 500.

It will be appreciated that a variety of different sealing arrangements 510 having different configurations suitable for different cable sizes and types can be used with the actuator assembly. Depending upon user preference and the type of cables intended to be sealed, different cable sealing modules can be mixed and matched within the actuator assembly. In some cases, all of the sealing module used at a given time within the actuator assembly may have the same configuration. In other cases, one or more of the cable sealing modules used at the same time within a given actuator assembly can have different configurations but can work to together to provide cable and enclosure sealing. Thus, any of the types of sealing modules disclosed herein can be used alone to fill an actuator assembly, or can be mixed with other types of the sealing modules to fill an actuator assembly.

In certain implementations, the optical sensor 520 can be mounted so that actuation of the gel block 512 triggers the optical sensor 520. For example, the optical sensor 520 can be positioned at the base 502 to extend into the gel block 512. In certain examples, the optical sensor 520 may include an actuation part 524 that is movably coupled to a body (e.g., holding sleeve) 522 of the sensor 520. Example suitable optical sensors include optical sensors 100, 200 of FIGS. 20 and 22 in which a stationary ferrule and a movable ferrule are disposed within the body and the movable ferrule is attached to the actuation part.

In some implementations, the actuation of the gel block 512 causes movement of the sealant, which presses against the actuation part 524 of the sensor 520 to trigger activation of the sensor 520. For example, when the gel block 512 is axially compressed, the gel block 512 expands over the actuation part 524 and moves the actuation part 524 towards the body 522. When the gel block 512 is released, the gel block 512 retracts away from the actuation part 524, thereby allowing the actuation part 524 to return to a default position relative to the body 522. In other implementations, the sealant may move the actuation part 524 towards the body 522 when the gel block 512 is released and allow movement of the actuation part 524 away from the body 522 when the gel block 512 is compressed.

In yet other implementations, the body 522 is coupled to one of the axially movable members 516 that compress (e.g., axially compress) the gel block 512. Accordingly, actuation of the gel block 512 moves the body 522 towards the actuation part 524, which is retained in place by the sealant, thereby activating the sensor 520. In still other implementations, the sensor 520 is actuated through movement of the body 522 by the bracket 528A and movement of the actuation part 524 by the sealant of the gel block 512 during actuation of the gel block 512.

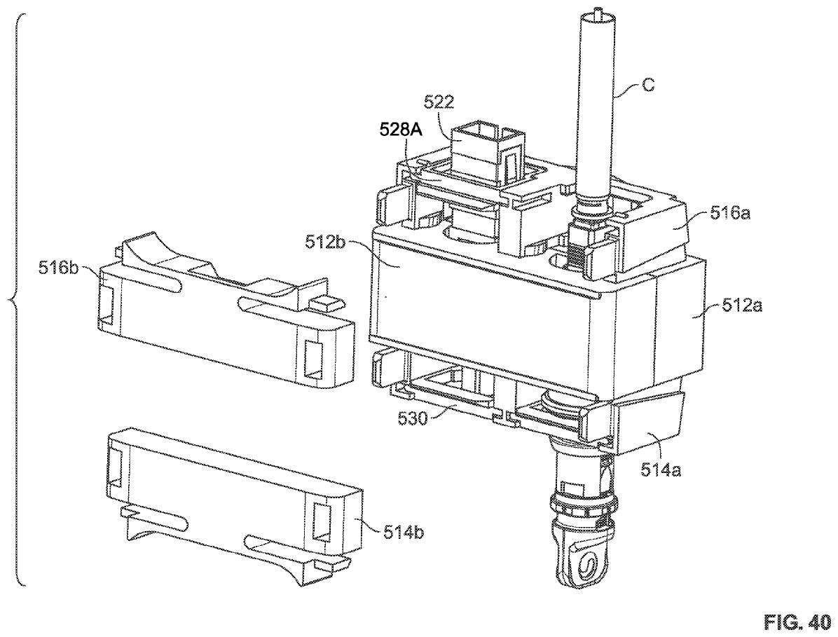

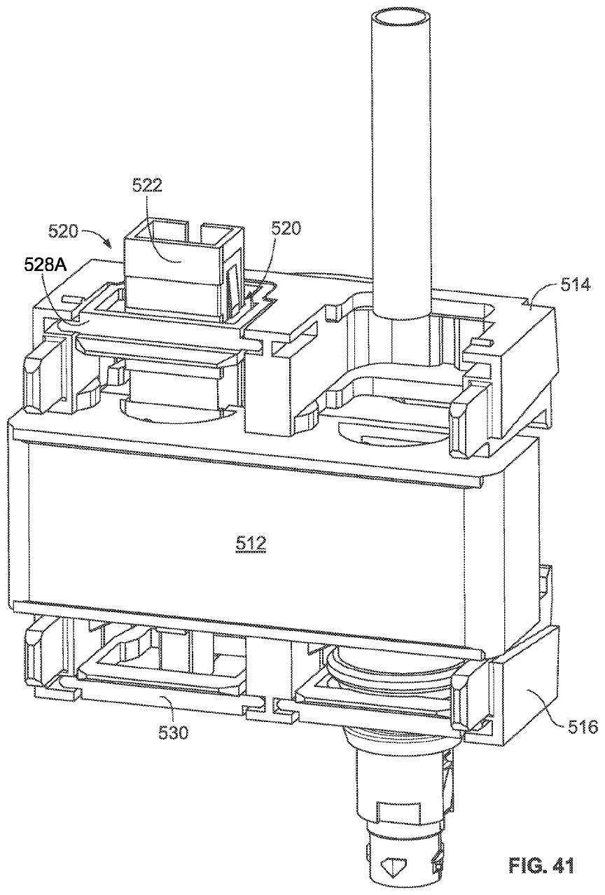

In certain implementations, the gel block 512 includes first and second gel blocks 512a, 512b disposed side-by-side between the axially movable members 514, 516 (e.g., see FIG. 40). Cables C to be sealed when passing into the closure 500 extend between the gel blocks 512a, 512b. When the gel blocks 512a, 512b are compressed by the members 514, 516, the gel blocks 512a, 512b expand towards each other and outwardly towards the cover 504. In certain examples, the optical sensor 520 can be disposed between the gel blocks 512a, 512b. Accordingly, when the gel blocks 512a, 512b are compressed, the sealant expands towards each other and hence towards the optical sensor 520 to move the actuation part 524.

In certain implementations, the body 522 of the optical sensor 520 is held by a bracket 528A that mounts to one of the axially movable members 514, 516. In certain examples, the bracket 528A slidably mounts within a pocket defined in one of the axially movable members 514, 516. In certain examples, each axially movable member 514, 516 includes a first piece 514a, 516a and a second piece 514b, 516b. In the example shown in FIG. 40, the first pieces 514a, 516a define the pockets in which the bracket 528A can mount and the second piece 514b, 516b completes the pocket when assembled to the first piece 514a, 516a.

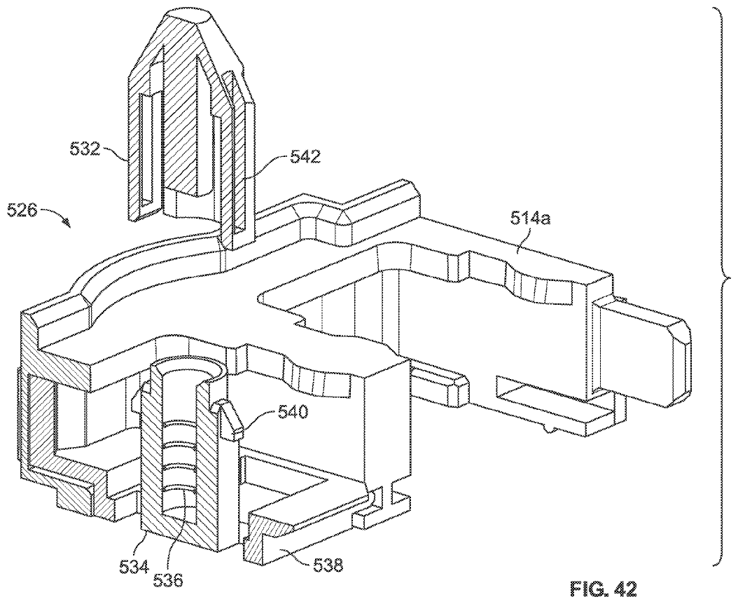

In certain implementations, a counterpart 526 is disposed within the gel block 512 opposite the actuation part 524. In certain examples, the counterpart 526 includes a base 538 that mounts within the pocket defined in the first piece 514a, 516a of the axially movable member 514, 516 opposite the sensor 520. The counterpart 526 accommodates variable movement of the axially movable members 514, 516. In certain examples, the counterpart 526 includes a first part 532 that movably mounts to a second part 534 (e.g., see FIG. 42). In certain examples, the first part 532 is biased away from the second part 534 by a spring 536 (e.g., a spring 536 disposed within the second part 534). In certain examples, the first part 532 is configured for limited travel relative to the second part 534. For example, stop members 540 extending outwardly from the second part 534 slide within grooves 542 defined by the first part 532 and inhibit removal of the first part 532 from the second part 534.

In certain implementations, the spring 536 is configured to provide a higher force than the spring (e.g., spring 16 of FIGS. 20 and 21) biasing the actuation part 524 of the optical sensor 520. Accordingly, when the gel block 512 is compressed, the gel first moves the actuation part 524 for the optical sensor 520 and then moves the first part 532 of the counterpart 526 towards the second part 534. The counterpart 526 moves to accommodate gel expansion beyond what could be accommodated by just the spring within the base 522 of the optical sensor 520. Accordingly, the counterpart 526 allows the optical sensor 520 to be utilized within a wider range of tolerances for the gel block

In certain implementations, a detection fiber extends from the optical sensor 520 further into the interior of the closure 500, through the fiber management components, and then out of the closure 500 through one of the cable ports. In certain examples, the detection fiber is grouped with one or more of the fibers carrying data signals through the closure 500 when routed out of the closure 500. In certain examples, the detection fiber may be routed to an input of an optical splitter or an optical coupler to combine the detection signal from the sensor 520 with the data signals from the data fibers routed to/from the closure 500. In an example, the optical sensor 520 includes an inner port 525 (FIG. 38) in which a connectorized end of the detection fiber can be plugged to connect the detection fiber to the optical sensor 520.

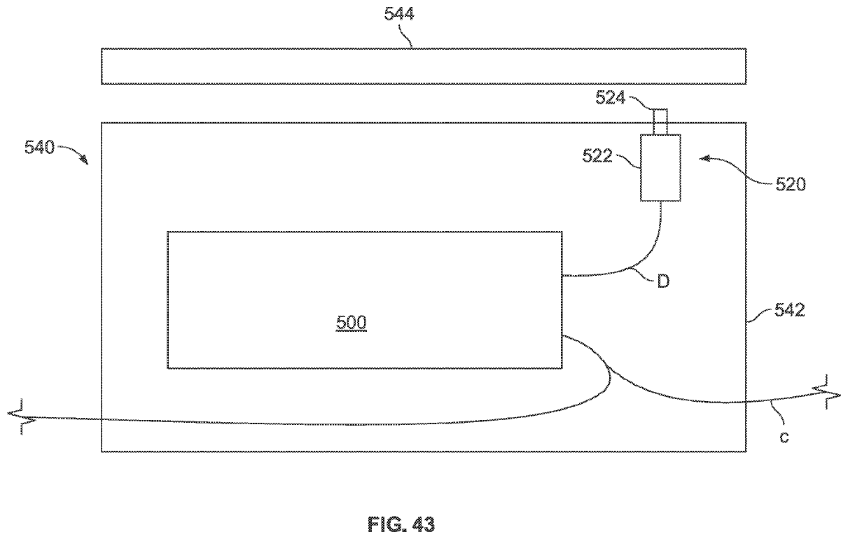

Referring to FIG. 43, an exterior optical sensor 520 can be disposed outside of the closure 500 but still have a corresponding detection fiber D routed into the closure 500 to be mechanically grouped with or optically split/coupled with the optical cables C passing through the closure 500. The exterior optical sensor 520 can be mounted to a handhole closure 540 in which the closure 500 is disposed. The handhole closure 540 may protect the closure 500 from contamination by dirt or other debris when the handhole closure 540 and the closure 500 are disposed underground. In certain examples, the handhole closure 540 includes a body 542 and a lid 544 that cooperate to surround the closure 500. The exterior optical sensor 520 may be positioned to trigger when the lid 544 is secured to the body 542 in a closed position. Accordingly, it is possible to remotely determine whether the handhole closure 540 is properly closed.

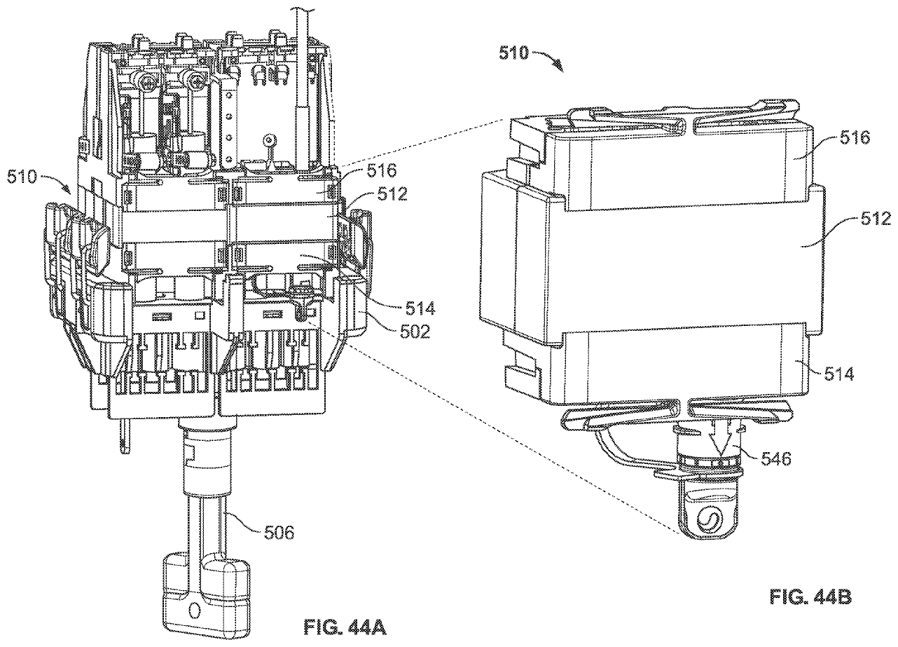

With additional reference to FIGS. 44A-B, in some embodiments it may be desirable to provide a ruggedized (e.g., hardened) fiber-optic adapter 546 on the exterior of the closure 500, thereby enabling optical cables to be more quickly connected and disconnected without the need to pass a cable through the gel block 512 each time that an optical cable is connected or disconnected. Because the fiber-optic adapter 546 is positioned on an exterior of the closure 500, the ruggedized fiber-optic connection may be environmentally sealed and may include robust fastening arrangements suitable for withstanding relatively large pull loading and sideloading.

It will be appreciated that a number of different types of ruggedized fiber optic connectors may be provided. International Publication Nos. WO2015/028433; WO2020/236512; and WO2021/041305, the contents of which are incorporated by reference to the extent that they do not conflict with the teachings disclosed herein, disclose various fiber optic connectors having different form-factors or configurations. The gel sealing module mounts in a dome style closure. Typically, the gel sealing module would be used to directly seal around cables routed into the enclosure. By mounting the adapter in the sealing module, the enclosure can be provided with a hardened connector port accessible from outside the enclosure.

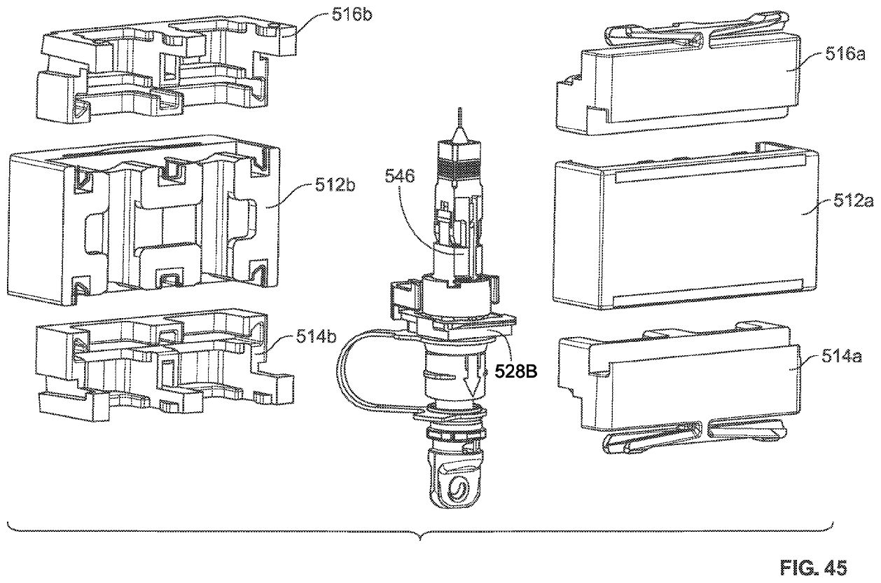

As depicted in FIG. 44B, in some embodiments, the fiber-optic adapter 546 can be at least partially contained within the cable anchoring and sealing arrangement 510. For example, in some embodiments, the fiber-optic adapter 546 can be mounted within a bracket 528B (as depicted in FIGS. 45-48), which can be engagingly coupled to either of the first or second axially movable pressure plates 514, 516, such that even when the gel block 512 is compressed between the pressure plates 514, 516 (e.g., via actuator 506), such that an interior of the closure is environmentally sealed, a pre-terminated, ruggedized fiber-optic cable can be operably coupled to the fiber-optic adapter 546.

With reference to FIG. 45, in some embodiments, the gel block 512 can include first and second gel blocks 512a, 512b disposed side-by-side between axial movable members 514, 516, which can each include respective first pieces 514a, 516a and second pieces 514b, 516b. In embodiments, the fiber-optic adapter 546 can be mounted to a bracket 528B, which can be adapted to be securely retained between a first piece 514a and second piece 514b of an axial movable member, thereby securing the fiber-optic adapter 546 to the sealing arrangement 510.

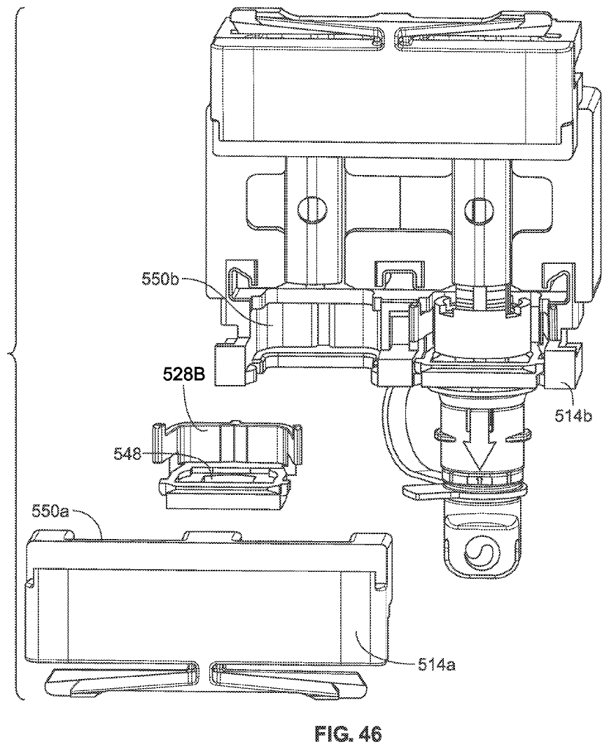

With additional reference to FIG. 46, the bracket 528B can define a mount opening 548 through which the fiber-optic adapter 546 can be mounted. The bracket 528B can be shaped and sized to fit within a bracket mounting channel 550a/550b defined by the respective first and second pieces 514a/514b of the axial movable member. Accordingly, in some embodiments, the bracket 528B can be at least partially supported by both the first and second pieces 514a/514b of the axial movable member, while providing a mount opening 548 shaped and sized to accommodate the fiber-optic adapter 546.

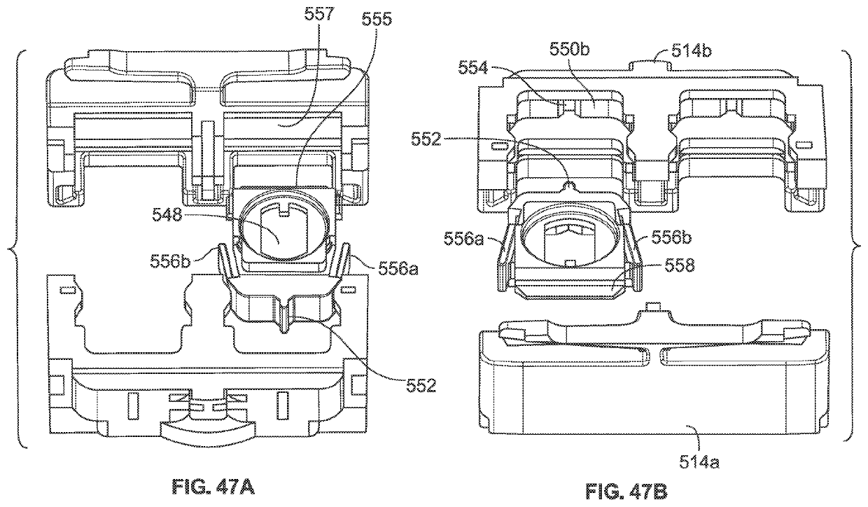

Moreover, in some embodiments, the bracket 528B can be keyed to fit within the bracket mounting channel 550a/550b defined by the respective first and second pieces 514a/514b. For example, with additional reference to FIGS. 47A/B, in some embodiments, the bracket 528B can define an alignment tab 552 configured to reside within an alignment groove 554 defined within the bracket mounting channel 550b. In some embodiments, the alignment tab/groove 552/554 can serve to align the bracket 528B relative to the axial movable member 514, as well as to inhibit rotation of the bracket 520 relative to the axial movable member 514. As an aid in stabilizing the bracket 528B relative to the first piece 514a, in some embodiments, the bracket 528B can include a support surface 555 configured to reside within a support surface receiving channel 557, defined by the first piece 514a.

One or more flexible arms 556a/b defined by the bracket 528B can be movable from a naturally biased outward position (as depicted in FIGS. 47A/B) to an insertion position, for insertion of the bracket 528B into the bracket mounting channel 550a/550b. Thereafter, the one or more flexible arms 556a/b can be configured to be naturally biased to the outward position to maintain pressure against an interior surface of the bracket mounting channel 550b, thereby maintaining the bracket 528B in position relative to the second piece 514b until the bracket 528B is secured between the first piece 514a and the second piece 514b.

In addition to supporting sensor 520 or fiber optic adapter 546, the brackets can define a mount opening configured to support the coupling of a wide variety of couplings, cables and adapters. In some embodiments, each coupling, cable and adapter can be paired with a unique adapter or size of adapter configured to support the coupling, cable and adapter within the sealing arrangement 510. For example, as depicted in FIGS. 40-41, in some embodiments, a first bracket 528A configured to secure at least a portion of a sensor 520 can be retained between the first piece 514a and the second piece 514b of the axially movable member. In another example, as depicted in FIGS. 45-47B, a second bracket 528B configured to secure at least a portion of a fiber-optic adapter 546 can be retained between the first piece 514a and the second piece 514b of the axially movable member.

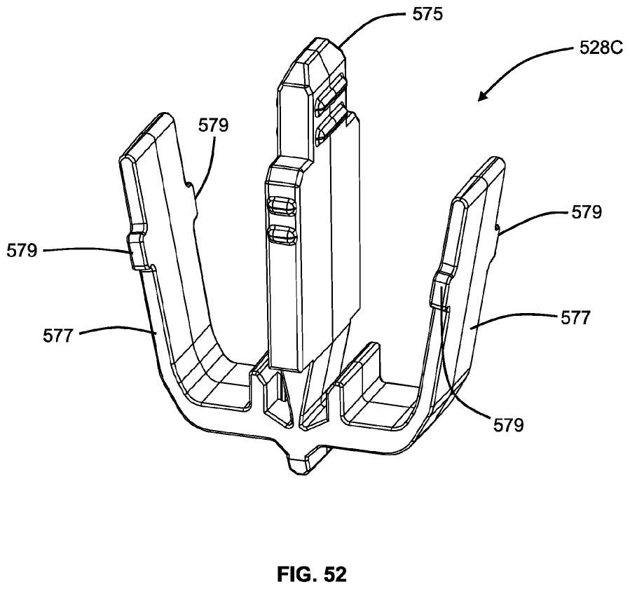

In another example, as depicted in in FIG. 52, a third bracket 528C can be used to facilitate installing smaller cables through the cable pass through location of the of the sealing arrangement 510. As depicted, in some embodiments, the bracket 528C can include a central divider 575 positioned between two latching arms 577. The latching arms 577 can be biased toward an outwardly angled orientation and remain in the outwardly angled orientation when at rest. The latching arms 577 are forced inwardly to a generally vertical position when the bracket 528C are installed between the first piece 514a and the second piece 514b of the axially movable member. In some embodiments, the mounting bracket channel 550b can include ramp surfaces that allow the bracket 528C to be pulled from the cable pass through locations without requiring the latching arms 577 to be manually flexed inward. Instead, when the bracket 528C is pulled one or more tabs 579 ride on the ramp surfaces causing the latching arms five is 77 to flex inwardly. In some embodiments, the central divider 575 is configured to pivot toward either of the latching arms 577 to accommodate cables of different size.

In vet other examples, the brackets 528A-C can be removed from the sealing arrangement 510 to enable a larger cable to pass through the cable pass through location of the sealing arrangement 510

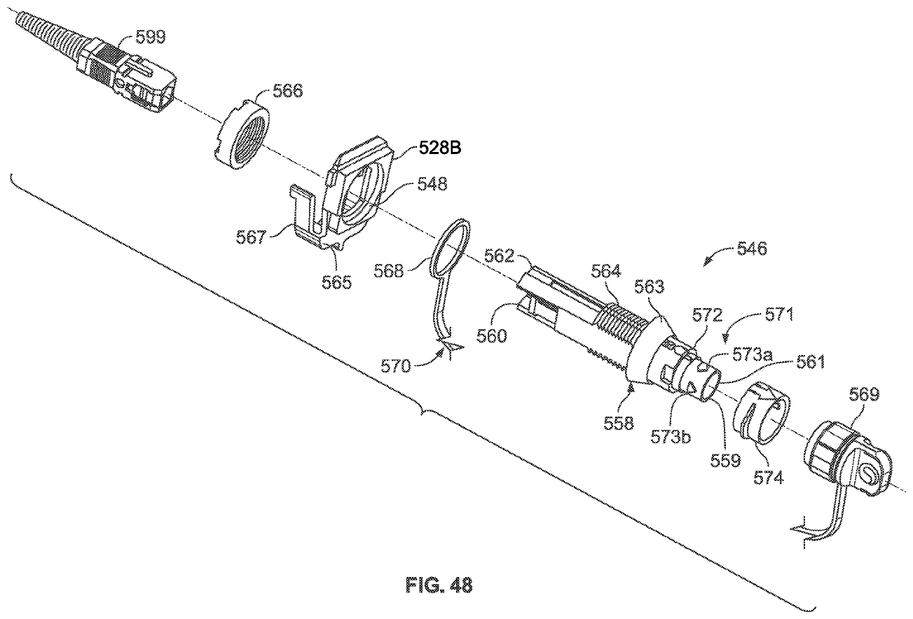

With reference to FIGS. 48-51, an exploded view of the fiber-optic adapter 546 configured to enable selective mating of a ruggedized fiber-optic connector 601 (e.g., positioned on an exterior of the closure 500) with a non-ruggedized fiber-optic connector 599 (e.g., positioned within an interior of the closure 500) is depicted in accordance with an embodiment of the disclosure. In embodiments, the fiber-optic adapter 546 is configured to mount within a mount opening 548 defined by the bracket 528B.

In embodiments, the fiber-optic adapter 546 can include a main body 558, having a first end 559 and a second end 560, wherein a length of the fiber-optic adapter 546 extends between the first and second ends 559, 560. In some embodiments, the first end 559 defines a ruggedized connector port 561 (e.g., connectable to a ruggedized fiber-optic connector 601) and can be referred to as the ruggedized end.

In embodiments, the main body 558 can be of a unitary (e.g., single piece), molded construction, which can have a form factor that matches or is otherwise compatible with a ruggedized fiber-optic connector. The second end 560 defines a non-ruggedized connector port 562 (e.g., connectable to a non-ruggedized fiber-optic connector 599) and can be referred to as the non-ruggedized end. In embodiments, the non-ruggedized end can be adapted to receive a non-ruggedized fiber optic connector 599 (e.g., SC or LC type fiber-optic connector or the like).

When the non-ruggedized fiber optic connector 599 is secured to the non-ruggedized connector port 562, and the ruggedized fiber-optic connector 601 is secured to the ruggedized connector port 561, the non-ruggedized fiber-optic connector 599 and the ruggedized fiber-optic connector 601 are optically connected together, such that the ruggedized and non-ruggedized fiber-optic cables are coaxially aligned to provide an optical connection between the optical fibers contained within each of the ruggedized and non-ruggedized fiber-optic cables.

The main body 558 can define an outer flange 563 and exterior threads 564. When the main body 558 is secured within the mounting opening 548 defined through the bracket 528B, the outer flange 563 engages a first side 565 of the bracket 528B, while a nut 566 is threaded onto the exterior threads 564 to engage a second side 567 of the bracket 528B. In this way, the bracket 528B is compressed between the outer flange 563 and the nut 566 to secure the main body 558 to the bracket 528B. In some embodiments, the fiber-optic adapter 546 can further include a gasket or other seal 568 (e.g., configured to abut up against the bracket 528B) when secured within the mount opening 548 to inhibit water and dirt intrusion through the mount opening 548.

In some embodiments, the fiber-optic adapter 546 can include a dust cap 569, which can optionally be tethered to the main body 558 via a lanyard 570. In embodiments, the dust cap 569 can be adapted to be secured over the ruggedized connector port 561 prior to inserting the ruggedized fiber-optic connector 601 therein. It will be appreciated that the dust cap 569 can be removed from the first end 559 of the main body 558 to allow insertion of the ruggedized fiber-optic connector 601.

As depicted in FIG. 50, the ruggedized fiber-optic connector 601 can include a connector core 603 terminating one end of the fiber-optic cable 605. A turn to secure fastener 607 is rotatably mounted on the connector core 603, and a strain relief boot 609 is mounted on the turn to secure fastener 607. The turn to secure fastener 607 mounts on the connector core 603 adjacent to a rear end of the connector core (i.e. adjacent at one end to which the cable is secured). In embodiments, the connector core 603 can include a front plug end 609 positioned opposite from a rear cable attachment end 611. The front plug end 609 optionally has a form factor compatible with an SC type fiber-optic adapter, but could have other form factors as well, such as an LC connector form factor compatible with an LC fiber-optic adapter. The fiber-optic cable 605 is attached are secured to the connector core 603 at the rear cable attachment end 611 of the connector core 603. The fiber-optic cable 605 can include an outer jacket 613. The outer jacket 613 of the fiber-optic cable 605 can be secured to the cable attachment end 611 of the connector core 603 by a sleeve 615, such as a shape memory sleeve (e.g., heat shrink sleeve). In certain examples, the heat shrink sleeve 615 can include an interior layer of adhesive for bonding the heat shrink sleeve to the outer jacket 613 and to the connector core 603. The turn to secure fastener 607 is mounted over the connector core 603 and can be turned (e.g., rotated) relative to the connector core 603 about a longitudinal axis 617. The turn to secure fastener 607 is captured axially between an outer stop 619 (e.g., a shoulder) of the connector core 603 and the front end of the sleeve 615, such that the turn to secure fastener 607 is retained on the connector core 603. The boot optionally can be turned in unison with the turn to secure fastener 607 about the axis 617.

An optical fiber structure 621 includes a first section 623 routed longitudinally through the outer jacket 613 of the fiber-optic cable and a second section 625 routed through the connector core 603. The second section 625 of the optical fiber structure 621 defines a fiber tip 627 at the front plug end 609 of the connector core 607. A front portion of the second section 625 of the optical fiber structure 621 is secured and supported within a ferrule 629. The ferrule 629 is spring biased in a forward direction relative to the connector core 603 by a spring 631. An inner body mounts within the connector core 603, and includes a front end that functions as a spring stop and a rear end that can include structure for use in securing strength members of the fiber-optic cable 605 to the connector core 603.

The coupling arrangement 571 can include two distinct interlock functions, including a first interlock function, including one or more snap fit features 572, adapted to inhibit rotation between the fiber-optic adapter 546 and the ruggedized fiber-optic connector 601, and a second interlock function, including one or more stops 573a/b (e.g., triangular projections, etc.), configured to establish axial retention between the fiber-optic adapter 546 and the turn to secure fastener 607 of the ruggedized fiber-optic connector 601.

Further, in some embodiments, the main body 558 can include a keyway 633 for receiving an elongate key 634 of the connector core 603. The main body 558 also includes internal structure rotationally guiding the keying rail to the keyway 633. In certain examples, the structure for providing rotational guiding can include two helical shoulders that rotate in opposite helical directions about a central longitudinal axis of the main body 558 as the shoulders extend along the axis in a direction from the first end 559 to the second end 560 of the main body 558. In certain examples, the keyway 633 can provide for rotational guiding of the connector core 603 as the connector core 603 is inserted into the ruggedized connector port 561 along a rotational range of movement of at least 90°, or at least 135°, or at least 170°, or about 180°.

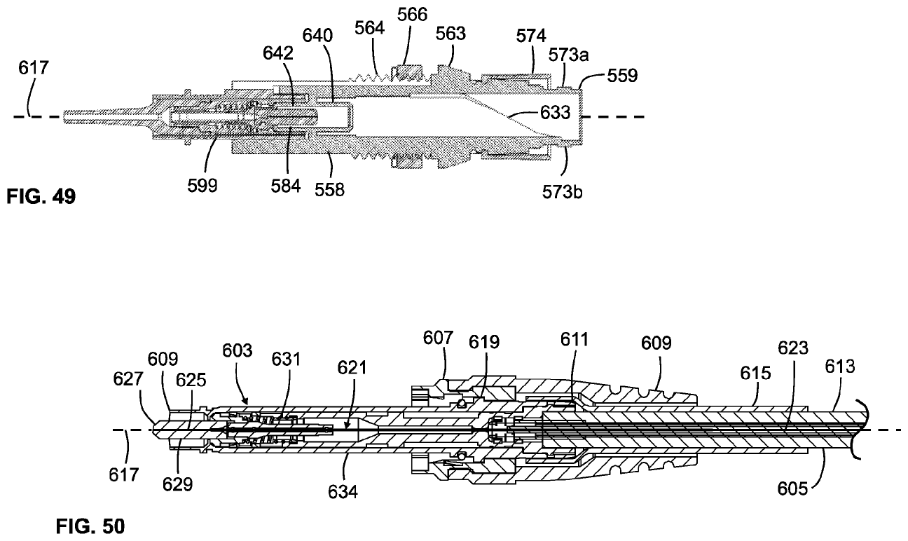

As depicted in FIG. 49, in some embodiments, the main body 558 can include an internal sleeve holder 640. In some embodiments, the internal sleeve holder 640 can contain a ferrule alignment sleeve, such as a split sleeve 642 made of an elastic material (e.g., phosphor bronze, zirconia, ceramic, etc.) in certain examples, the internal sleeve holder 640 can include a plurality of fingers that can be flexed open to allow the split sleeve 642 to be inserted within and retained within the internal sleeve holder 640. For example, a ferrule 584 of the non-ruggedized fiber-optic connector 599 can be received within one end of the ferrule alignment sleeve 642 housed within the sleeve holder 640 and the ferrule 629 of the ruggedized connector 601 can be received within the opposite end of the ferrule alignment sleeve 642, thereby coaxially aligning the two ferrules 584, 629 to provide an optical connection between the optical fibers held by each of the ferrules 584, 629.

In certain examples, the fiber-optic adapter 546 further includes a retention collar 574 that mounts over the exterior of the main body 558 adjacent to the first end 559. The retention collar 574 is non-rotatably mounted relative to the main body 558 such that the retention collar 574 cannot be rotated about the central axis of the main body 558. The retention collar 574 is moveable between an extended position and a retracted position. A detent is provided for retaining the retention collar 574 in the extended position and in the retracted position. When the retention collar 574 is moved to the extended position while a ruggedized fiber optic cable is in a coupled rotational position relative to the fiber-optic adapter 546, retaining member (e.g., fingers) inside the retention collar 300 extend within the interior of the ruggedized fiber optic cable and oppose the stop surfaces of the interior coupling arrangement of the ruggedized fiber optic cable. In this way, the retention collar 574 prevents the ruggedized fiber optic cable from being rotated from the coupled rotational position back to the non-coupled rotational position. In contrast, when the retention collar 574 is moved to the retracted position, the retaining members 305 disengage from the stop surfaces thereby allowing the ruggedized fiber optic cable to be rotated from the coupled rotational position back to the non-coupled rotational position when sufficient torque is applied to the turn-to-secure fastener to overcome the detent 572 and move the ruggedized fiber optic cable from the coupled rotational position back to the non-coupled rotational position.

In certain examples, the retention collar 574 can be spring biased toward the extended position. In this way, the retention collar 574 can automatically move from the retracted position to the extended position once the ruggedized fiber optic cable is turned from the non-coupled rotational state to the coupled rotational state. To de-couple the ruggedized fiber optic cable, the collar 574 can be manually slid from the extended position to the retracted position against the bias of the spring to allow for rotation of the ruggedized fiber optic cable from the coupled rotational state to the non-coupled rotational state. Insertion of the ruggedized fiber optic cable into the fiber-optic adapter 546 can cause movement of the collar 574 from the extended position to the retracted position (e.g., via physical contact between the retaining sleeve and the core assembly) against the bias of the spring.

Accordingly, the sealing arrangement 510 includes first and second axially movable member 514, 516 that are separable to allow a fiber optic adapter 546 to be loaded between the first and second axially movable member 514, 516. The sealing arrangement 510 includes sealing gel block 512 contained between first and second axially movable member 514, 516. The first and second axially movable member 514, 516 are adapted to interlock with inner and outer pressurization structures of an actuator 506 used to pressurize the gel 512 between the first and second axially movable member 514, 516. The first and second axially movable member 514, 516 define cable receiving locations (e.g., notches, openings) for routing cables through the first and second axially movable members 514, 516 and through the gel 512. A cable pass-through orientation (e.g., fiber optic adapter 546) extends transversely between the first and second axially movable members 514, 516 and through a thickness of the gel 512 defined between the first and second axially movable members 514, 516. The sealing arrangement 510 is adapted to force the first and second axially movable members 514, 516 together in an orientation along the cable pass-through axis to pressurized the gel 512 within the sealing arrangement 510 to provide sealing. In one example, the first and second axially movable members 514, 516 each generally form half-portions 514a/b and 516a/b of a the sealing arrangement 510. When assembled the half-portions 514a/b and 516a/b mechanically engage each other (e.g., include engagement portions that overlap, or engagement portions that mate, etc.) to allow load to be transferred in both directions along the cable pass-through orientation between the first and second axially movable members 514, 516 to define the full gel block 512 volume of the sealing arrangement 510.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

### CROSS-REFERENCE TO RELATED APPLICATION

This application is being filed on Nov. 8, 2022 as a PCT International Patent Application and claims the benefit of U.S. Provisional Application No. 63/277,095, filed on Nov. 8, 2021, and claims the benefit of U.S. Patent Application Ser. No. 63/301,841, filed on Jan. 21, 2022 and claims the benefit of U.S. Patent Application Ser. No. 63/401,969, filed on Aug. 29, 2022, the disclosures of which are hereby incorporated herein by reference in their entireties.

### TECHNICAL FIELD

The present disclosure relates generally to enclosures such as telecommunications enclosures. More particularly, the present disclosure relates to a sensor for detecting activity of a telecommunications enclosure.

### BACKGROUND

Telecommunications systems typically employ a network of telecommunications cables capable of transmitting large volumes of data and voice signals over relatively long distances. Telecommunications cables can include fiber optic cables, electrical cables, or combinations of electrical and fiber optic cables. A typical telecommunications network also includes a plurality of telecommunications enclosures integrated throughout the network of telecommunications cables. The telecommunications enclosures (or “closures”) are adapted to house and protect telecommunications components such as splices, termination panels, power splitters, wave division multiplexers, fiber management trays, cable organizing and routing components, etc.

Typically, telecommunications closures house a fiber organizing assembly having equipment for organizing fibers, storing fibers, and optically connecting provider side fibers to subscriber side fibers. A given closure can accommodate different types of optical connections between fibers, such as connector to connector connections and fiber splices.

Fiber optic closures receive cables extending to and from the closure, while protecting the internal cables and connections in a sealed environment. The closure is typically re-enterable wherein the seal is de-activated, and then later re-activated.

There is a need to monitor activity with respect to the closure over time. U.S. Pat. Nos. 9,741,229, 9,892,614, 10,034,546, and 10,694,850 concern optical sensors and monitoring devices.

### SUMMARY

In one aspect, a sensor system is provided for detecting activity at a fiber optic closure. One example is whether the fiber optic closure has been opened. Another example is whether movable components within the closure are moved.

The sensor system can monitor authorized movements with respect to the closure, such as opening and closing the closure, or moving components within the closure. In this system, tracking of technician activity can be monitored. The sensor system can also monitor unauthorized movements with respect to the closure. In some implementations, the sensor can track opening/closing of an access opening of the closure. In other implementations, the sensor can track movement of one or more components within the closure. In still other implementations, the sensor can track actuation/de-actuation of a gel block within the closure. In still other implementations, the sensor can track opening/closing of a housing (e.g., a handhole closure) surrounding the closure.

In one aspect, the present disclosure relates to an optical sensor, in particular an optical sensor capable of sensing mechanical movement, and an optical sensor assembly and a monitoring device having the optical sensor. The optical sensor uses an Optical Time Domain Reflectometer (OTDR) signal for sensing mechanical movement, and communicating the sensed movement to a remote location, such as a central office.

A variety of additional inventive aspects will be set forth in the description that follows. The inventive aspects can relate to individual features and to combinations of features. It is to be understood that both the forgoing general description and the following detailed description are exemplary and explanatory only and are not restrictive of the broad inventive concepts upon which the embodiments disclosed herein are based.

### BRIEF DESCRIPTION OF THE DRAWINGS

The accompanying drawings, which are incorporated in and constitute a part of the description, illustrate several aspects of the present disclosure. A brief description of the drawings is as follows:

FIG. 1 is a perspective view of a first example of a fiber optic closure.

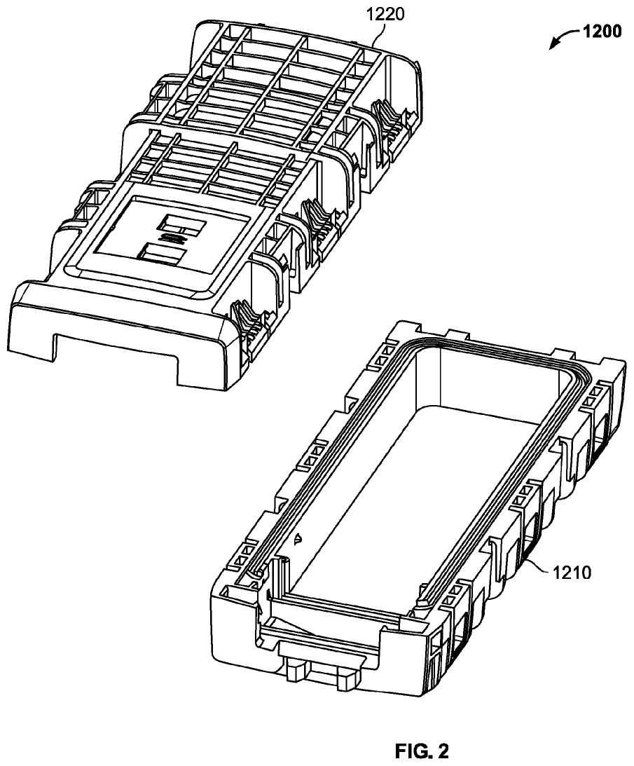

FIG. 2 is a view of the closure of FIG. 1 showing a cover removed from a base, and no internal components present.

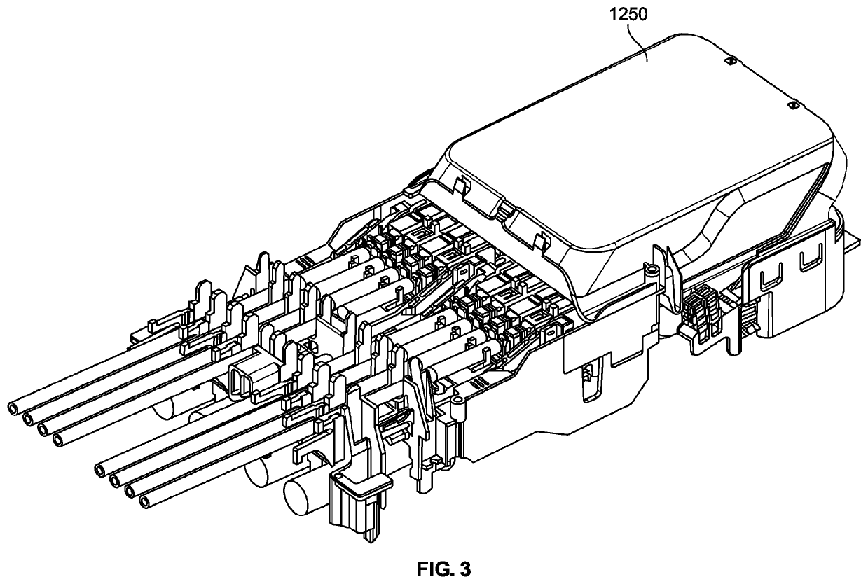

FIG. 3 is a view of internal components of the closure of FIGS. 1 and 2 showing internal features and cabling extending to and from the closure.

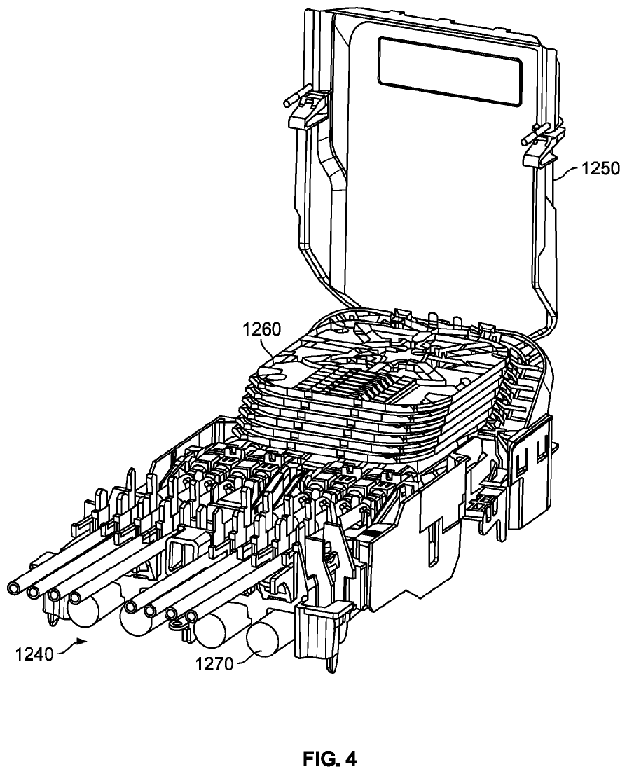

FIG. 4 is a further view of the internal components of FIG. 3, showing an internal cover in an open position.

FIG. 5 is a perspective view of a second example of a fiber optic closure.

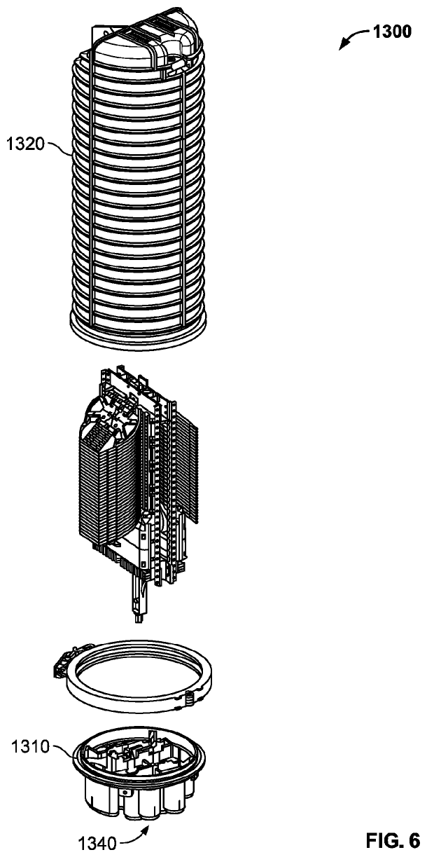

FIG. 6 is an exploded view of the closure of FIG. 5.

FIG. 7 is a view of the internal components of FIG. 5.

FIG. 8 shows one example of a sensor for detecting the status of a cover of a fiber optic closure.

FIG. 9 shows another example of a cover sensor for detecting the status of a cover of a fiber optic closure.

FIG. 10 shows another example of a cover sensor for detecting the status of a cover of a fiber optic closure.

FIG. 11 shows a first position of the cover of FIG. 10 relative to the cover sensor.

FIG. 12 shows a second position of the cover of FIG. 10 relative to the cover sensor.

FIG. 13 shows a tray sensor positioned relative to one tray of a set of internal rotatable trays in a fiber optic closure.

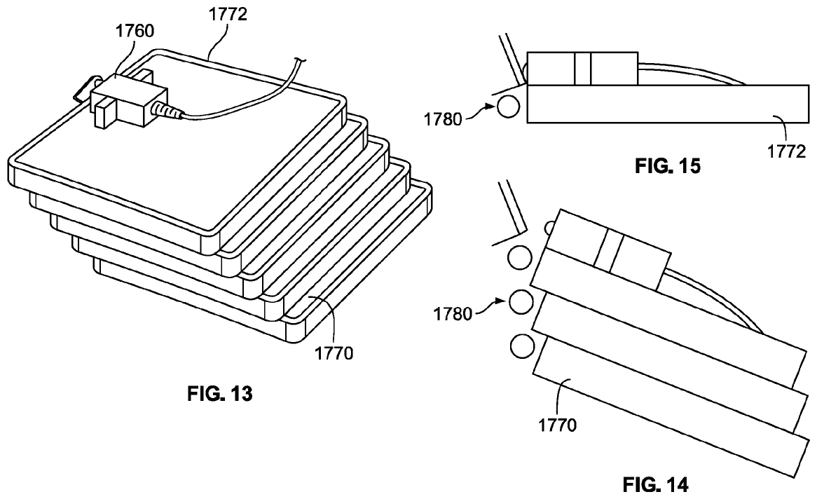

FIG. 14 shows the tray sensor of FIG. 13 and the monitored tray in a side view.

FIG. 15 shows the monitored tray of FIG. 14 in a rotated position to activate the tray sensor.

FIG. 16 shows a seal sensor for sensing the status of a gel seal in a fiber optic closure.

FIG. 17 shows two alternative spring elements useable with a position sensor to introduce an increased range of movement for the sensor.

FIG. 18 shows a different spring element used with a position sensor to introduce an increased range of movement for the sensor.

FIG. 19 shows a schematic arrangement of multiple closures relative to a central office including a sensor system for sensing the status of activity within a closure.

FIG. 20 shows a sectional schematic view of an optical sensor according to the present disclosure.

FIG. 21A shows a sectional schematic view of the optical sensor shown in FIG. 1 when an actuator is not compressed.

FIG. 21B shows a sectional schematic view of the optical sensor shown in FIG. 1 when the actuator is compressed.

FIG. 22 shows a perspective schematic view of an optical sensor according to a first exemplary embodiment of the present disclosure.

FIG. 23 shows a partially exploded schematic view of the optical sensor shown in FIG. 3.

FIG. 24 shows a perspective schematic view of the housing and main body frame of the optical sensor shown in FIG. 23.

FIG. 25 shows a perspective schematic view of the main body frame mounted in the housing in FIG. 24.

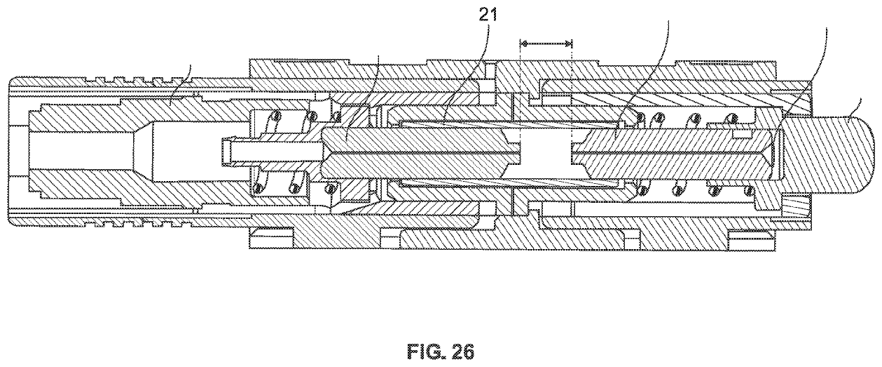

FIG. 26 shows a sectional schematic view vertically sectioned through the optical sensor shown in FIG. 22 along the central axis, with the actuator not compressed.

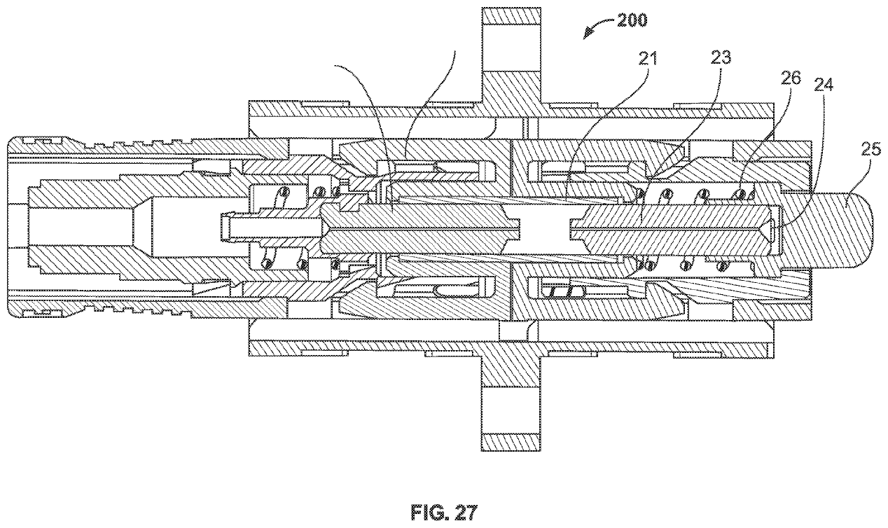

FIG. 27 shows a sectional schematic view horizontally sectioned through the optical sensor shown in FIG. 22 along the central axis, with the actuator not compressed.

FIG. 28A shows a schematic view of a monitoring device according to a first exemplary embodiment of the present disclosure.

FIG. 28B shows a curve diagram of light intensity acquired at an optical time domain reflectometer as a function of distance when the monitoring device shown in FIG. 28A operates.

FIG. 29A shows a schematic view of a monitoring device according to a fifth exemplary embodiment of the present disclosure.

FIG. 29B shows a curve diagram of light intensity acquired at an optical time domain reflectometer as a function of distance when the monitoring device shown in FIG. 29A operates.

FIG. 30 shows a schematic block diagram of a monitoring system for monitoring multiple monitored points by using the monitoring device according to the present disclosure.

FIG. 31 is a block diagram illustrating aspects of an example of a sensor system in accordance with the present disclosure.

FIG. 32 is a block diagram illustrating aspects of another example of a sensor system in accordance with the present disclosure.

FIG. 33 is a block diagram illustrating aspects of an example of a closure monitoring system in accordance with the present disclosure.

FIG. 34 is a chart illustrating example optical time-domain reflectometer signals of a monitoring system such as that shown in FIG. 33.

FIG. 35 is a block diagram illustrating aspects of another example of a sensor system in accordance with the present disclosure.

FIG. 36 is a chart illustrating example optical time-domain reflectometer signals of a sensor system such as that shown in FIG. 35.

FIG. 37 is a perspective view of another example fiber optic closure in which an optical sensor can be disposed.

FIG. 38A is a perspective view of a base of the fiber optic closure of FIG. 37 showing an example optical sensor disposed at a gel block of a cable anchoring and sealing arrangement of the fiber optic closure.

FIG. 38B is an exploded perspective view of a base of the fiber optic closure of FIG. 38A showing an example optical sensor disposed at a gel block of a cable anchoring and sealing arrangement of the fiber optic closure.

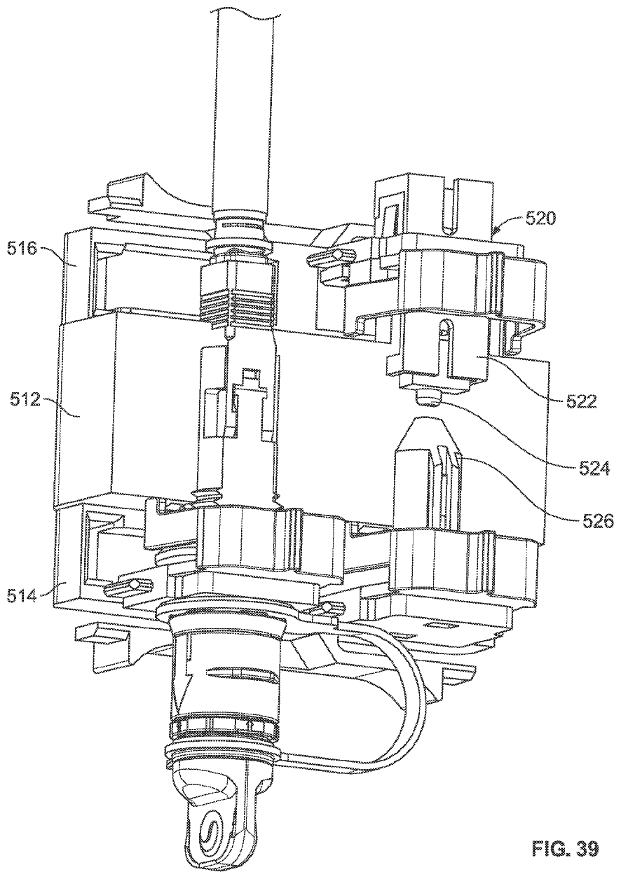

FIG. 39 shows the base, gel block, and optical sensor of FIG. 38 with a portion of the gel block removed for ease in viewing the optical sensor.

FIG. 40 shows the cable anchoring and sealing arrangement with pieces of the axially moving members exploded from a remainder of the cable anchoring and sealing arrangement.

FIG. 41 shows the cable anchoring and sealing arrangement assembled with the actuation part of the optical sensor extending into the gel block.

FIG. 42 is a cross-sectional view of a counterpart of the optical sensor in an exploded state.

FIG. 43 shows an exterior optical sensor that is disposed outside of the optical enclosure of FIG. 37 at an access opening of a handhole closure and that is connected to fibers extending into the optical enclosure.

FIG. 44A is a perspective view of another example fiber optic closure in which a fiber optic connection can be disposed.

FIG. 44B is a close-up perspective view of sealing arrangement mounting in which a fiber optic connection is disposed.

FIG. 45 is an exploded view of a sealing arrangement mounting in which a fiber optic connection is disposed.

FIG. 46 is a partially disassembled view of a sealing arrangement mounting in which a fiber optic connection is disposed.

FIG. 47A is a first perspective view of an axially movable member in which a fiber optic connection is disposed.

FIG. 47B is a second perspective view of an axially movable member in which a fiber optic connection is disposed.

FIG. 48 is an exploded view of a fiber optic adapter mounted within a bracket of an axially movable member.

FIG. 49 is a cross sectional view of a fiber optic adapter and non-ruggedized connector, in accordance with an embodiment of the disclosure.

FIG. 50 is a cross sectional view of a ruggedized connector, in accordance with an embodiment of the disclosure.

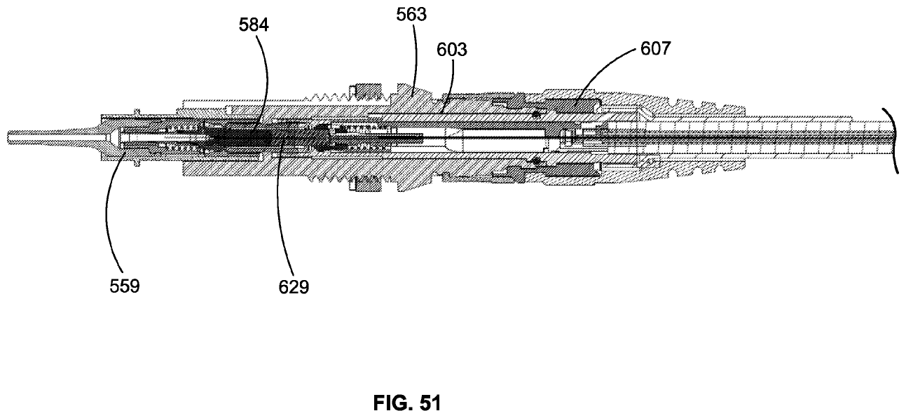

FIG. 51 is a cross sectional view of the fiber optic adapter and non-ruggedized connector of FIG. 49 coupled with the ruggedized connector of FIG. 50, in accordance with an embodiment of the disclosure.

FIG. 52 is a perspective view of a bracket to facilitate installing smaller cables through a cable pass through location of a sealing arrangement, in accordance with an embodiment of the disclosure.

### DETAILED DESCRIPTION

Referring now to FIGS. 1-4, a first and second type of closure 1200 is shown including a base 1210, a cover 1220, and a cable seal region 1240. Within the first closure 1200, various conductivity components are provided for connecting incoming and outgoing cables. In the examples shown, an internal cover 1250 is positioned over a plurality of rotatable trays 1260 for containing fiber slack and splices. A sensor can be provided for detecting whether the cover 1220 is removed from the base 1210. A sensor can be provided for whether the gel seal 1240 associated with incoming and outgoing cables has been activated. A sensor can be provided to detect whether the internal cover 1250 has been removed relative to a remainder of interior components. A sensor can be provided for detecting whether one or more of the rotatable trays 1260 have been moved.

The sensors usable in first closure 1200 can be optical sensors using an OTDR signal for sensing mechanical movement, and communicating the sensed movement to a remote location, such as a central office, through one of feeder cables 1270. This feeder cable may or may not also carry data signals.

Referring now to FIGS. 5-7, a different type of closure 1300 is provided having a base 1310, a dome cover 1320, and a cable seal region 1340. Incoming and outgoing cables are provided. A sensor can be used for detecting whether the cover 1320 has been removed from the base 1310. A sensor can also be provided to detect whether any of the rotatable trays 1360 have been moved.

Referring now to FIG. 8, a closure 1400 is shown similar to the closure 1200 of FIGS. 1-4. A sensor 1460 is provided to detect whether the cover 1420 has been removed relative to the base 1410. Sensor 1460 can be factory installed or field installed.

Referring now to FIG. 9, a closure 1500 similar to the closure 1300 of FIGS. 5-7 is shown with a sensor 1560 to detect whether a dome cover 1520 has been removed relative to a base 1510. Sensor 1560 can be mounted to internal frame 1550 of the closure 1500 that hold rotating trays, like trays 1360.

In FIGS. 10-12, a sensor 1660 is positioned in an alternative arrangement relative to the arrangement of FIG. 8 for detecting whether a cover 1620 has been moved relative to a base 1610. In particular, the sensor 1460 of FIG. 8 is shown axially aligned with cover 1420 that is moved along the sensor axis 1470. In FIGS. 10-12, the sensor 1660 is positioned substantially orthogonal to the sensor axis 1670. An angled activation tab 1680 on the cover 1620 is positioned to move the sensor 1660 to indicate whether the cover 1620 has been moved relative to the base 1610.

In FIGS. 13-15, a sensor 1760 is positioned on one of the rotatable trays 1770. If the top tray 1772 is rotated, the sensor 1760 is activated to indicate relative rotation of the tray and a tray mount 1780.

FIG. 16 shows a sensor 1860 positioned to detect whether a gel seal 1880 positioned between two components of a closure (for example, a cover and a base, or a port seal) has been activated/triggered or de-activated/untriggered. The sensor 1860 responds to movement of the gel seal 1880 as the seal is compressed to a sealed state between positions as the status of the gel seal goes between activated and deactivated.

FIG. 17 shows a sensor 1960 including a spring feature for adding tolerance to the sensor 1960 such that the range of operation of the sensor 1960 is increased. Either or both a leaf springs 1970, 1980 can be added to increase tolerances of sensor 1960. FIG. 18 shows an alternative arrangement for a sensor 2060 including a spring feature to increase the range of operation of the sensor. Coil springs 2070 can be added to increase tolerances of sensor 2060.

FIG. 19 shows signal communication between a central office and various closures in the system wherein a change in status of a closure (e.g., one of the closures depicted in FIG. 1018) is communicated to the central office, such as through an OTDR signal. The various sensors (e.g., sensors 1460, 1560, 1660, 1760, 1860, 1960, or 2060, as depicted in FIGS. 1-18) can be factory installed or field installed. The sensors can be moved over time to detect movement of different aspects, such as different trays.

In FIGS. 20-36, example sensors are shown which detect relative movement between components. U.S. Pat. Nos. 9,741,229, 9,892,614, 10,034,546, and 10,694,850 concern optical sensors and monitoring devices, the disclosures of which are hereby incorporated by reference. Other sensors and communications systems can be used including NB-LTE radio-access technology. Another technology that can be used is the LoRaWAN-Low Power, Wide Area (LPWA) networking protocol which wirelessly connect battery operated sensors to the internet in the networks.

FIG. 20 shows a sectional schematic view of an optical sensor 100 according to the present disclosure. According to the present disclosure, the optical sensor 100 can include a holding sleeve 11, a fixed ferrule 12 for optically coupling with an optical fiber of an optical cable and fixedly mounted in the holding sleeve 11, a movable ferrule 13 movably mounted in the holding sleeve 11 at a predetermined distance D1 existing between a first movable end of the movable ferrule 13 and a first fixed end of the fixed ferrule 12 in the holding sleeve 11, a reflection part 14 arranged at a second movable end of said movable ferrule 13 opposite to said first movable end, for reflecting light entering the movable ferrule 13, and an actuation part 15, said actuation part 15 being constructed to drive the movable ferrule 13 to move so that the first movable end of the movable ferrule 13 comes into contact with the first fixed end of the fixed ferrule 12, so as to allow an optical fiber hole 121 of the fixed ferrule 12 to contact with an optical fiber hole 131 of the movable ferrule 13.

The optical sensor 100 further comprises a reset device 16, said reset device 16 being arranged between the movable ferrule 13 and the actuation part 15, and when the actuation part 15 contracts towards the interior of the optical sensor 100 due to a pressure being applied, the actuation part 15 drives the movable ferrule 13 to move against the force of the reset device 16. The reset device 16 can be a spring surrounding the movable ferrule 13, and can also be a reset device whose movement is based on magnetic force or another device capable of automatically driving the actuation part to reset.

Generally, as shown in FIG. 21A, when the actuation part 15 is in an uncompressed state, due to the action of the reset device 16, a predetermined distance D1 is kept between the first movable end of the movable ferrule 13 and the first fixed end of the fixed ferrule 12 in the holding sleeve 11, so that a beam of light from the fixed ferrule 12 will freely diverge at the first fixed end while only a very small part of the beam can be incident to the movable ferrule and reflected back to the fixed ferrule by the reflection part 14.

On the other hand, as shown in FIG. 21B, when the actuation part 15 is compressed, the actuation part 15 overcomes the acting force of the reset device 16 and drives the movable ferrule 13 to move towards the fixed ferrule 12, so that the first movable end of the movable ferrule 13 comes into contact with the first fixed end of the fixed ferrule 12, so as to allow the optical fiber hole 121 of the fixed ferrule 12 to contact with the optical fiber hole 131 of the movable ferrule 13. Thus, most of the beam from the fixed ferrule 12 will be incident to the movable ferrule and reflected back to the fixed ferrule 12 by the reflection part 14. The reflected beam can be transmitted to an optical time domain reflectometer through an optical cable transmission device, so as to detect the condition where the actuation part 15 is driven (which will be described in detail

According to the optical sensor 100 of the present disclosure, the reflection part 14 can be a flat reflection face formed on the second movable end of the movable ferrule 13, such as by grinding, polishing treatment, film coating, attaching a reflector mirror and the like, for reflecting the beam incident to the movable ferrule 13 and emitting a reflected beam from the movable ferrule 13. In one embodiment, the reflection face can provide a reflection characteristic independent of wavelength. In another embodiment, the reflection face can also provide a selective waveband reflection characteristic dependent on wavelength. In an alternative embodiment, the reflection part 14 is a smooth and flat reflection face formed on the actuation part 15 and in sealed connection with the second movable end of the movable ferrule 13, and thus can also reflect a beam incident to the movable ferrule 13 and emit a reflected beam from the movable ferrule 13.

Furthermore, a limiting part 17 is arranged on the movable ferrule 13, the limiting part 17 being constructed to limit the distance of movement of said movable ferrule 13. The limiting part 17 can be used to prevent the movable ferrule 13 from excessively pressing the fixed ferrule 12 when the actuation part 15 contracts, and from separating from the optical sensor 100 when the actuation part 15 extends due to the action of the reset device 16. Alternatively, the limiting part can also be arranged on the actuation part 15.

According to the optical sensor 100 of the present disclosure, the end surfaces of the first fixed end of the fixed ferrule 12 and of the first movable end of the movable ferrule 13 are constructed to be parallel with each other and form an angle relative to the axis of the holding sleeve 11. Preferably, the end surfaces of the first fixed end and the first movable end are inclined by an angle of between about 5° to about 10° (e.g., 8°, etc.), relative to the axis of the holding sleeve 11. This inclined structure facilitates a tight contact between the end surfaces of the first fixed end and the first movable end, and minimizes light loss when a beam is transmitted between the fixed ferrule 12 and the movable ferrule 13. However, the present disclosure is not limited to such an inclined end surface, and those skilled in the art can understand that the inclination of the end surfaces of the first fixed end and first movable end relative to the axis of the holding sleeve 11 can be set to be perpendicular, or they have curved surface structures complementary to each other, as long as a beam is maximally transmitted between the fixed ferrule and movable ferrule after they are in contact.

FIGS. 22-27 show an optical sensor 200 according to an embodiment of the present disclosure, the optical sensor 200 having the same basic structure as the optical sensor 100. Particularly, referring to FIGS. 22-27, the optical sensor 200 can include a holding sleeve 21, a fixed ferrule 22 for optically coupling with an optical fiber of an optical cable and fixedly mounted in the holding sleeve 21, a movable ferrule 23 movably mounted in the holding sleeve 21 a predetermined distance D2 existing between a first movable end of said movable ferrule 23 and a first fixed end of the fixed ferrule 22 in the holding sleeve 21, a reflection part 24 arranged at a second movable end of said movable ferrule 23 opposite to said first movable end, for reflecting light entering the movable ferrule 23, and an actuation part 25, said actuation part 25 being constructed to drive the movable ferrule 23 to move so that the first movable end of the movable ferrule 23 comes into contact with the first fixed end of the fixed ferrule 22. The optical sensor 200 further includes a reset device 26, said reset device 26 being arranged between the holding sleeve 21 and the actuation part 25, and when the actuation part 25 contracts towards the interior of the optical sensor 200 due to a pressure being applied, the actuation part 25 drives the movable ferrule 23 to move against the force of the reset device 26.

The optical sensor 200 further includes a main body frame 27 and a guide frame 28. The holding sleeve 21 is fixedly arranged in the main body frame 27, the guide frame 28 is mounted on the main body frame 27, and the actuation part 25 is movably mounted on the guide frame 28. Particularly, the actuation part 25 passes through a through hole 282 formed on an end part 281 of the guide frame 28, and a protruding limiting part 251 arranged on the actuation part 25 is arranged on the inner side of the end part 281, so as to prevent the actuation part 25 from moving completely out of the guide frame 28, the limiting part 251 is provided with a guide protrusion 252, and said guide frame 28 is provided with a guide groove 283 matching the guide protrusion 252. As such, with the cooperation of the guide protrusion 252 and guide groove 283, the actuation part 25 pushes the movable ferrule 23 to move axially and rotation of the actuation part 25 and the movable ferrule 23 is prevented.

The optical sensor 200 further includes a housing 29, the main body frame 27 being mounted in the housing 29. Referring to FIGS. 25-27, the main body frame 27 can include a base part 271 mounted on the housing 29, a sleeve holder 272 extending from the base part 271, the holding sleeve 21 being held in the sleeve holder 272, and two opposite extension arms 273, the sleeve holder 272 being arranged between the two extension arms 273. An engagement protrusion 274 protruding inwards is formed on a free end of the extension arm 273 and, correspondingly, an engagement groove 284 is formed on the guide frame 28. After a spring as the reset device 26 is sheathed on the movable ferrule 23 and the actuation part 25 is allowed to extend out of the interior of the guide frame 28 via the through hole 282, the guide frame 28 can be inserted into the housing 29 and the engagement protrusion 274 is engaged with the engagement groove 284, so as to hold the guide frame 28 in the housing 29. A positioning frame 285 can be further mounted between the housing 29 and the guide frame 28, to stably mount the guide frame 28 inside the housing 29. It can be understood that the positioning frame 285 can also be omitted and some positions on the guide frame 28 are constructed to be in direct contact with the interior of the housing 29, so that the guide frame 28 can also be held inside the housing 29. Furthermore, a mounting part 291 is arranged on the outside of the housing 29, and a mounting hole 292 is arranged on the mounting part 291. As such, the optical sensor 200 can be mounted onto a monitored object such as a closure arranged in the field, using a bolt structure.

FIGS. 28A-36 show implementation of the example sensors for passively detecting relative movement of two components. According to an embodiment of a still further aspect of the present disclosure, a monitoring device is provided which includes at least one optical sensor assembly as described in the embodiments above and an OTDR (optical time domain reflectometer). The optical sensors of the optical sensor assembly are respectively mounted to at least one monitored object, such as a closure. The optical time domain reflectometer is constructed to emit a main beam towards said optical sensors through the optical cable transmission device of the optical sensor assembly and receive a reflected beam reflected from said optical sensors, and the optical path distances between the optical time domain reflectometer and the optical sensors are different from one another.

FIG. 28A shows a schematic view of a monitoring device 400 according to an exemplary embodiment of the present disclosure. The monitoring device 400 comprises an optical sensor assembly and an optical time domain reflectometer 406. The optical sensor assembly comprises the optical sensors 100, 200 and 300 according to the present disclosure and an optical cable transmission device. The optical sensor 100 is mounted to a closure, and the optical sensor is configured such that the actuation part 15 of the optical sensor is pressed when a cover of the closure is closed (or opened), so as to result in movement of the movable ferrule towards the fixed ferrule. The optical time domain reflectometer 406 emits a main beam towards the optical sensor 100 through the optical cable transmission device 101 and receives a reflected beam reflected from the optical sensor 100.

The monitoring device 400 of the first embodiment further comprises a shunt 408, which is constructed to split a detection beam out of the main beam from the optical time domain reflectometer 406, the detection beam being transmitted to an optical sensor assembly. More specifically, the optical time domain reflectometer 406 is optically connected with the shunt 408 through a main optical cable transmission device 405. Furthermore, the main optical cable transmission device 405 comprises two optical fibers, of which one optical fiber is connected with the optical time domain reflectometer 406 and the other optical fiber is connected with a service network 407 to transmit communication information to the closure. Examples of the shunt can include a PLC shunt, a circulator, or an equivalent shunt device. The shunt 408 comprises multiple optical channels, such as 16 or 32 optical channels, wherein one optical channel 16 or optical channel 32 is connected with the optical cable transmission device 101 connected to an optical sensor 100, for transmitting a detection beam and a reflected beam reflected from the optical sensor 100 while the other optical channels 1-15 or 1-31 are used for transmitting other optical information signals.

The intensity of the reflected beam can be acquired at the optical time domain reflectometer 406. FIG. 28B shows a curve diagram of the light intensity acquired at an optical time domain reflectometer as a function of distance when the monitoring device shown in FIG. 28A operates. As shown in FIG. 28B, in the process of transmitting a beam in the optical fiber and the shunt, the light intensity acquired at the optical time domain reflectometer 406 decreases with the length of the optical fiber (i.e., the distance between the optical sensor and the optical time domain reflectometer) or decreases due to passing through a high attenuation device such as the shunt.

When the cover of the closure is closed, the actuation part 15 of the optical sensor 100 is pressed, resulting in a movement of the movable ferrule 13 so that the first movable end of the movable ferrule 13 comes into contact with the first fixed end of the fixed ferrule 12 and, when the optical fiber hole 121 of the fixed ferrule 12 contacts with the optical fiber hole 131 of the movable ferrule 13, most of the detection beam from the fixed ferrule 12 is incident to the movable ferrule 13 and reflected back to the fixed ferrule 12 by the reflection part 14. The reflected beam is further transmitted to the optical time domain reflectometer 406 and therefore the light intensity acquired by the optical time domain reflectometer 406 shows a pulsed jump. The optical time domain reflectometer 406 further converts the change in light intensity into a change in electric signal, so as to detect the closure of the cover of the closure according to the change in electric signal.

Although an exemplary embodiment, in which an optical pulse can be acquired at the optical time domain reflectometer when the closure is closed, has been described as above, the present disclosure is not limited thereto. Those skilled in the art understand that the optical sensor can be mounted such that the actuation part 15 is driven when the cover of the closure is opened, to drive the movable ferrule 13 to move towards the fixed ferrule, so that the generation of an optical pulse signal is detected at the optical time domain reflectometer 406, so as to determine that the cover of the closure has been opened. In a further alternative embodiment, when the optical sensor is mounted such that when the cover is opened, the actuation part 15 drives the movable ferrule 13 to move away from the fixed ferrule due to the acting force of the reset device, a decreased or disappearing optical pulse signal is detected at the optical time domain reflectometer 406, so as to determine that the cover of the closure has been opened. It can be understood that the degree of opening of the cover of the closure can be determined by using the change in intensity of the optical pulse signal detected at the optical time domain reflectometer 406.

As shown in FIG. 30, an integrated management platform arranged in a central machine room can monitor in real time the opening or closing of the cover of the closure. If the cover of the closure is opened not for a normal reason, for example opened accidentally, or opened due to technical personnel or engineering personnel forgetting to close it, or opened due to being impacted or stolen, the integrated management platform activates an automatic alarm platform to send an alarm signal, for example, by using a mobile terminal alarm, audible and visual alarm, web alarm, or other types of alarms which can be sensed by related personnel.

FIG. 29A shows a schematic view of a monitoring device 800 according to another exemplary embodiment of the present disclosure. The monitoring device 800 comprises at least multiple optical sensor assemblies as described in the embodiments above and an optical time domain reflectometer. The optical sensors of the optical sensor assemblies are respectively mounted to at least one monitored object, such as a closure. The monitored objects are divided into multiple groups: for example, each group of monitored objects is arranged in one region, and at least one optical sensor assembly is arranged for each group of monitored objects.

The monitoring device 800 further comprises multiple splitters 808 connected in series, each splitter 808 splits a detection beam from a previous stage into a main detection beam and a detection sub-beam, and each splitter 808 is arranged in a propagation path of the detection main beam and each optical sensor 101 receives the corresponding detection sub-beam. Furthermore, the light flux ratio of the main detection beam and detection sub-beam output from each splitter 808 is in a range of between about 20:80 and about 1:99.

FIG. 29B shows a curve diagram of light intensity acquired at an optical time domain reflectometer as a function of distance when the monitoring device 800 shown in FIG. 29A operates. As shown in FIG. 29B, the light intensity acquired by the optical time domain reflectometer 806 shows multiple pulse jumps, each pulse corresponding to one optical sensor. The optical time domain reflectometer 806 further converts the change in light intensity into a change in electric signal, so as to detect the opening of the cover of the corresponding closure according to the change in electric signal.

FIG. 30 shows a schematic block diagram of a monitoring system for monitoring multiple monitored points using the monitoring device of the present disclosure. As shown in FIG. 30, the mechanical state of one monitored object (such as monitored objects A-Z), multiple monitored points of one monitored object (such as monitored points A-Z of monitored object A), or multiple groups of monitored objects can be monitored using the monitoring device of the present disclosure based on optical sensors.

Referring now additionally to FIGS. 31-36, this disclosure relates to remote monitoring of passive optical network elements, based on the reflected power at certain discrete points along an optical fiber. FIG. 31 illustrates an example of a sensor system in accordance with aspects of the present disclosure. The illustrated sensor system 1010 includes a sensor 1012 coupled to an optical fiber 1014 and a reflector 1016. The reflector 1016 is configured to provide a reflected optical signal. Power can be reflected by metal coated fibers, Thin Film Filters (TFF) or Bragg grating devices, for example.

In certain embodiments of the illustrated sensor system 1010, the sensor 1012 is situated in a closure 1100. The reflected power is intensity modulated in response to a parameter 1018 associated with the closure 1100, such as moisture in the closure, closure temperature, intrusion into the closure, etc. These modulated reflections can be detected with a conventional optical time-domain reflectometer (OTDR). An OTDR is an optoelectronic instrument used to characterize an optical fiber. Optical pulses are injected into an end of the optical fiber 1014, and light reflected back from points along the fiber 1014 is extracted from the same end of the fiber 1014 and analyzed. The strength of the return pulses is measured as a function of time, and is plotted as a function of fiber length. Embodiments of the disclosed sensor system provide a fully passive optical sensor system (no electricity or battery required at the monitored closure).

In the example of FIG. 31, a dedicated optical fiber 1014 is provided for monitoring parameters of the closure 1100. FIG. 32 illustrates an example that includes a fiber optic tap 1020 that provides a connection to the sensor 1012. In some implementations, a multiplexing scheme, such as wavelength division multiplexing (WDM), is used to allow the same fiber 1014 to be used both for monitoring and for communications.

FIG. 33 illustrates an implementation where three tap couplers 1020 are coupled to the fiber 1014 to connect to three sensors in respective closures 1100a, 1100b, 1100c. The optical fiber 1014 is coupled to an OTDR 1030 that receives light reflected from the reflectors 1016 associated with the sensors 1012 for each of the closures 1100a, 1100b, 1100c. FIG. 34 illustrates an example of the return pulses plotted as a function of distance, thus providing a pulse 1022a, 1022b, 1022c corresponding to each of the closures 1100a, 1100b, 1100c.

The OTDR may further be connected to a monitoring system 1050 that provides information regarding the monitored closures, alarms, data logging, etc. The monitoring system 1050 could be implemented by any suitable computing system. In some examples, the monitoring system 1050 includes an appropriately programmed processor configured to execute various processes for analyzing the OTDR signals. A system memory stores an operating system for controlling the operation of the monitoring system.

The system memory is computer-readable media. Examples of computer-readable media include computer storage media and communication media. Computer storage media is physical media that is distinguished from communication media. Computer storage media includes physical volatile and nonvolatile, removable and non-removable media implemented in any method or technology for persistent storage of information, such as computer-readable instructions, data structures, program modules, or other data. Computer storage media also includes, but is not limited to, RAM, ROM, EEPROM, flash memory or other memory technology, CD-ROM, DVD or other optical storage, magnetic cassettes, magnetic tape, magnetic disk storage or other magnetic storage devices, or any other medium which can be used to persistently store desired information and which can be accessed by the monitoring system 1050. Any such computer storage media may be part of or external to the monitoring system 1050.

Communication media is typically embodied by computer-readable instructions, data structures, program modules, or other data, in a modulated data signal, such as a carrier wave or other transport mechanism, and includes any information delivery media. The term “modulated data signal” means a signal that has one or more of its characteristics set or changed in such a manner as to encode information in the signal. By way of example, communication media includes wired media such as a wired network or direct-wired connection, and wireless media such as acoustic, RF, infrared and other wireless media.

The monitoring system 1050 may further include one or more input and output devices, such as a keyboard, mouse, a display, etc. The monitoring system 1050 can be connected to the OTDR 1030 and other computing devices via a network that provides a data communication path for data transfer between the OTDR 1030 and the monitoring system 1050.

FIG. 35 illustrates another example where a plurality of parameters (cover, tray, temperature, water, humidity, intrusion) can be monitored for the same closure 1100 or at a single location using a single optical fiber 1014. A fiber optic tap 1020 is coupled to an optical fiber 1014 and to a 1:4 splitter 1041, which is connected to a plurality of sensor systems 1010a, 1010b, 1010c. As disclosed above, each of the sensor systems 1010 includes sensor parts 1012 and a corresponding first reflector 1016 as shown, for example, in FIGS. 23 and 24. Each of the sensors 1010a, 1010b, 1010c is connected to the splitter 1040 via a corresponding time delay device such as delay loops 1042a, 1042b, 1042c, with each delay loop having a different length to delay the OTDR signal a different time period for each reflected signal. The second reflector 1016 is further coupled to the splitter 1040 to provide a reference signal. In some implementations, each sensor monitors a different parameter 1018a, 1018b, 1018c. A comparison of the reflected optical signals from each of the sensors 1010a, 1010b, 1010c to the second optical signal from the reference reflector 1017 provides an indication of the plurality of monitored parameters.

For example, the sensor system 1010 could monitor three movable aspects of a single closure, or a variety of other parameters such as humidity, intrusion and temperature for a single closure. Humidity or moisture sensors could be formulated using a material that swells or expands in response to moisture. As the material swells, it presses an optical fiber in a “sawtooth” cavity or a cavity with radiused curves. A temperature sensor can be formed using a bi-metal structure that similarly deforms s fiber in response to temperature variation.

FIG. 36 illustrates examples of various OTDR signals generated by the system shown in FIG. 35. The pulse 1023 is the reference pulse from the reflector 1017, and the other three pulses 1024a, 1024b, 1024c correspond to the signals reflected from the reflectors associated with the sensors 1010a, 1010b, 1010c. As noted above, each of the sensors 1010a, 1010b, 1010c is coupled to the splitter 1040 via a respective delay loop 1042a, 1042b, 1042c, so the OTDR pulses associated with the respective sensors are spaced along the distance axis. Comparing each of the sensor pulses 1024a, 1024b, 1024c to the reference pulse 1023 results in a corresponding Δh signal, Δha, Δhb, Δhc. When the monitored parameter 1018 changes, it results in the respective sensor attenuating the reflected signal, which in turn changes the pulse height as compared to the reference pulse 1023.

FIG. 37-43 illustrate another example closure 500 in which an optical sensor 520 is disposed. The closure 500 includes a base 502 to which a cable anchoring and sealing arrangement 510 is mounted. The closure 500 also includes a cover 504 (e.g., a dome style cover) that mounts to the base 502 to enclose the cable anchoring and sealing arrangement 510 within an interior of the closure 500.

The cable anchoring and sealing arrangement 510 which can include pressurization structures (e.g., walls, plates, parts, components, elements, structures, etc.) between which sealant can be axially contained and pressurized. In certain examples, the sealing arrangement 510 can include one or more parts, including a gel block 512 of gel or other sealant disposed between first and second axially movable members 514, 516 (e.g., pressure plates). In certain examples, the sealing arrangement 510 can include a frame structure and sealant containment walls coupled to the frame structure. The sealant containment walls can be integrated as part of sealing modules and can function to provide containment of sealant of the sealing modules. At least one of the axially movable members 514, 516 is attached to an actuator system 506 that extends outwardly from the base 502, so that the actuator system 506 is accessible from an exterior of the closure 500. For example, in one embodiment, the actuator system 506 can include a spring for biasing the pressurization structures together to pressurize the sealant.

In one embodiment, the closure 500 includes a sealing arrangement 510 that mounts within an opening for sealing about one or more cables desired to be routed into an interior of the closure 500 through one or more openings. The sealing arrangement 510 can be configured to provide peripheral sealing of the closure 500 about a perimeter located between the base 502 and the cover 504. In the example shown, the closure 500 includes a cover 504 (e.g., a dome style cover) defining an opening at one end, and a base 502 that mounts to the end of the cover 504. In certain examples, the base 502 can be detachably secured to the cover 504 by a mechanical fastening arrangement that can include latches, clamps, fasteners, or the like. The sealing arrangement 510 can be retained in the opening by the base 502. In some embodiments, a frame supporting fiber-optic components (e.g., optical splice trays, optical splitter trays, etc.) can be at least partially contained within the closure 500.

In one example, the sealing arrangement 510 includes a volume of sealant that may be formed by one or more sections or blocks of sealant (e.g., gel blocks 512) defining a plurality of cable pass through locations (e.g., ports, interfaces between adjacent sections of sealant, etc.). When pressurized, the gel blocks 512 are configured for providing seals about structures (e.g., cables, plugs, etc.) routed through the pass through locations of the gel blocks 512 and are also configured for providing a peripheral seal between the base 502 and the cover 504 about a boundary (e.g., perimeter, profile, etc.) of the opening of the cover 504.

In one example, the actuator system 506 includes inner and outer pressurization structures 517, 518 between which the gel blocks 512 are pressurized. The actuator system 506 can include a threaded drive system that drives relative movement of the pressurization structures 517, 518 to pressurize the gel blocks 512. Torque for driving the threaded drive system can be provided by a torque application interface such as a handle 507. A spring can be incorporated into the actuation arrangement for applying a pressurization load. Example actuator arrangements are disclosed by PCT International Publication No. WO2014/005916, which is hereby incorporated by reference in its entirety.

The sealant of the gel blocks 512 is pressurized between the inner and outer sealant pressurization structure 517, 518 when the inner and outer pressurization structures 517, 518 are forced toward each other by rotating the handle 507 in a first rotational direction and the sealant of the gel blocks 512 is de-pressurized when the inner and outer pressurization structures 517, 518 are moved away from each other by rotating the handle 507 in a second rotational direction opposite form the first rotational direction. As used herein an axial direction or orientation is in an orientation along an axis 511 of the actuator arrangement.

The gel blocks 512 are provided as part of sealing arrangement 510 that removably mount between the inner and outer pressurization structures 517, 518. The sealing arrangements 510 each include a volume of sealant (e.g., gel block 512, etc.) positioned axially between axially movable members 514, 516. Accordingly, when in the actuated position, the axially movable members 514, 516 apply a compressive load to the gel block 512, such that the gel block 512 expands radially outwardly to seal against the cover 504 when compressed. In certain examples, the gel block 512 expands radially inwardly to seal against cables routed through the gel block 512 when compressed.

As depicted in FIG. 38B, the sealing arrangements 510 are insertable into and removeable from mounting locations 519 defined by inner and outer sealant pressurization structure 517, 518. The sealing arrangements 510 are insertable into the mounting locations 519 in laterally inward insertion directions and are removeable from the mounting locations 519 in laterally outward removable directions. In some embodiments, the insertion and removal directions are substantially orthogonal with respect to the axial direction of the closure 500.

It will be appreciated that a variety of different sealing arrangements 510 having different configurations suitable for different cable sizes and types can be used with the actuator assembly. Depending upon user preference and the type of cables intended to be sealed, different cable sealing modules can be mixed and matched within the actuator assembly. In some cases, all of the sealing module used at a given time within the actuator assembly may have the same configuration. In other cases, one or more of the cable sealing modules used at the same time within a given actuator assembly can have different configurations but can work to together to provide cable and enclosure sealing. Thus, any of the types of sealing modules disclosed herein can be used alone to fill an actuator assembly, or can be mixed with other types of the sealing modules to fill an actuator assembly.

In certain implementations, the optical sensor 520 can be mounted so that actuation of the gel block 512 triggers the optical sensor 520. For example, the optical sensor 520 can be positioned at the base 502 to extend into the gel block 512. In certain examples, the optical sensor 520 may include an actuation part 524 that is movably coupled to a body (e.g., holding sleeve) 522 of the sensor 520. Example suitable optical sensors include optical sensors 100, 200 of FIGS. 20 and 22 in which a stationary ferrule and a movable ferrule are disposed within the body and the movable ferrule is attached to the actuation part.

In some implementations, the actuation of the gel block 512 causes movement of the sealant, which presses against the actuation part 524 of the sensor 520 to trigger activation of the sensor 520. For example, when the gel block 512 is axially compressed, the gel block 512 expands over the actuation part 524 and moves the actuation part 524 towards the body 522. When the gel block 512 is released, the gel block 512 retracts away from the actuation part 524, thereby allowing the actuation part 524 to return to a default position relative to the body 522. In other implementations, the sealant may move the actuation part 524 towards the body 522 when the gel block 512 is released and allow movement of the actuation part 524 away from the body 522 when the gel block 512 is compressed.

In yet other implementations, the body 522 is coupled to one of the axially movable members 516 that compress (e.g., axially compress) the gel block 512. Accordingly, actuation of the gel block 512 moves the body 522 towards the actuation part 524, which is retained in place by the sealant, thereby activating the sensor 520. In still other implementations, the sensor 520 is actuated through movement of the body 522 by the bracket 528A and movement of the actuation part 524 by the sealant of the gel block 512 during actuation of the gel block 512.

In certain implementations, the gel block 512 includes first and second gel blocks 512a, 512b disposed side-by-side between the axially movable members 514, 516 (e.g., see FIG. 40). Cables C to be sealed when passing into the closure 500 extend between the gel blocks 512a, 512b. When the gel blocks 512a, 512b are compressed by the members 514, 516, the gel blocks 512a, 512b expand towards each other and outwardly towards the cover 504. In certain examples, the optical sensor 520 can be disposed between the gel blocks 512a, 512b. Accordingly, when the gel blocks 512a, 512b are compressed, the sealant expands towards each other and hence towards the optical sensor 520 to move the actuation part 524.

In certain implementations, the body 522 of the optical sensor 520 is held by a bracket 528A that mounts to one of the axially movable members 514, 516. In certain examples, the bracket 528A slidably mounts within a pocket defined in one of the axially movable members 514, 516. In certain examples, each axially movable member 514, 516 includes a first piece 514a, 516a and a second piece 514b, 516b. In the example shown in FIG. 40, the first pieces 514a, 516a define the pockets in which the bracket 528A can mount and the second piece 514b, 516b completes the pocket when assembled to the first piece 514a, 516a.

In certain implementations, a counterpart 526 is disposed within the gel block 512 opposite the actuation part 524. In certain examples, the counterpart 526 includes a base 538 that mounts within the pocket defined in the first piece 514a, 516a of the axially movable member 514, 516 opposite the sensor 520. The counterpart 526 accommodates variable movement of the axially movable members 514, 516. In certain examples, the counterpart 526 includes a first part 532 that movably mounts to a second part 534 (e.g., see FIG. 42). In certain examples, the first part 532 is biased away from the second part 534 by a spring 536 (e.g., a spring 536 disposed within the second part 534). In certain examples, the first part 532 is configured for limited travel relative to the second part 534. For example, stop members 540 extending outwardly from the second part 534 slide within grooves 542 defined by the first part 532 and inhibit removal of the first part 532 from the second part 534.

In certain implementations, the spring 536 is configured to provide a higher force than the spring (e.g., spring 16 of FIGS. 20 and 21) biasing the actuation part 524 of the optical sensor 520. Accordingly, when the gel block 512 is compressed, the gel first moves the actuation part 524 for the optical sensor 520 and then moves the first part 532 of the counterpart 526 towards the second part 534. The counterpart 526 moves to accommodate gel expansion beyond what could be accommodated by just the spring within the base 522 of the optical sensor 520. Accordingly, the counterpart 526 allows the optical sensor 520 to be utilized within a wider range of tolerances for the gel block

In certain implementations, a detection fiber extends from the optical sensor 520 further into the interior of the closure 500, through the fiber management components, and then out of the closure 500 through one of the cable ports. In certain examples, the detection fiber is grouped with one or more of the fibers carrying data signals through the closure 500 when routed out of the closure 500. In certain examples, the detection fiber may be routed to an input of an optical splitter or an optical coupler to combine the detection signal from the sensor 520 with the data signals from the data fibers routed to/from the closure 500. In an example, the optical sensor 520 includes an inner port 525 (FIG. 38) in which a connectorized end of the detection fiber can be plugged to connect the detection fiber to the optical sensor 520.

Referring to FIG. 43, an exterior optical sensor 520 can be disposed outside of the closure 500 but still have a corresponding detection fiber D routed into the closure 500 to be mechanically grouped with or optically split/coupled with the optical cables C passing through the closure 500. The exterior optical sensor 520 can be mounted to a handhole closure 540 in which the closure 500 is disposed. The handhole closure 540 may protect the closure 500 from contamination by dirt or other debris when the handhole closure 540 and the closure 500 are disposed underground. In certain examples, the handhole closure 540 includes a body 542 and a lid 544 that cooperate to surround the closure 500. The exterior optical sensor 520 may be positioned to trigger when the lid 544 is secured to the body 542 in a closed position. Accordingly, it is possible to remotely determine whether the handhole closure 540 is properly closed.

With additional reference to FIGS. 44A-B, in some embodiments it may be desirable to provide a ruggedized (e.g., hardened) fiber-optic adapter 546 on the exterior of the closure 500, thereby enabling optical cables to be more quickly connected and disconnected without the need to pass a cable through the gel block 512 each time that an optical cable is connected or disconnected. Because the fiber-optic adapter 546 is positioned on an exterior of the closure 500, the ruggedized fiber-optic connection may be environmentally sealed and may include robust fastening arrangements suitable for withstanding relatively large pull loading and sideloading.

It will be appreciated that a number of different types of ruggedized fiber optic connectors may be provided. International Publication Nos. WO2015/028433; WO2020/236512; and WO2021/041305, the contents of which are incorporated by reference to the extent that they do not conflict with the teachings disclosed herein, disclose various fiber optic connectors having different form-factors or configurations. The gel sealing module mounts in a dome style closure. Typically, the gel sealing module would be used to directly seal around cables routed into the enclosure. By mounting the adapter in the sealing module, the enclosure can be provided with a hardened connector port accessible from outside the enclosure.

As depicted in FIG. 44B, in some embodiments, the fiber-optic adapter 546 can be at least partially contained within the cable anchoring and sealing arrangement 510. For example, in some embodiments, the fiber-optic adapter 546 can be mounted within a bracket 528B (as depicted in FIGS. 45-48), which can be engagingly coupled to either of the first or second axially movable pressure plates 514, 516, such that even when the gel block 512 is compressed between the pressure plates 514, 516 (e.g., via actuator 506), such that an interior of the closure is environmentally sealed, a pre-terminated, ruggedized fiber-optic cable can be operably coupled to the fiber-optic adapter 546.

With reference to FIG. 45, in some embodiments, the gel block 512 can include first and second gel blocks 512a, 512b disposed side-by-side between axial movable members 514, 516, which can each include respective first pieces 514a, 516a and second pieces 514b, 516b. In embodiments, the fiber-optic adapter 546 can be mounted to a bracket 528B, which can be adapted to be securely retained between a first piece 514a and second piece 514b of an axial movable member, thereby securing the fiber-optic adapter 546 to the sealing arrangement 510.

With additional reference to FIG. 46, the bracket 528B can define a mount opening 548 through which the fiber-optic adapter 546 can be mounted. The bracket 528B can be shaped and sized to fit within a bracket mounting channel 550a/550b defined by the respective first and second pieces 514a/514b of the axial movable member. Accordingly, in some embodiments, the bracket 528B can be at least partially supported by both the first and second pieces 514a/514b of the axial movable member, while providing a mount opening 548 shaped and sized to accommodate the fiber-optic adapter 546.

Moreover, in some embodiments, the bracket 528B can be keyed to fit within the bracket mounting channel 550a/550b defined by the respective first and second pieces 514a/514b. For example, with additional reference to FIGS. 47A/B, in some embodiments, the bracket 528B can define an alignment tab 552 configured to reside within an alignment groove 554 defined within the bracket mounting channel 550b. In some embodiments, the alignment tab/groove 552/554 can serve to align the bracket 528B relative to the axial movable member 514, as well as to inhibit rotation of the bracket 520 relative to the axial movable member 514. As an aid in stabilizing the bracket 528B relative to the first piece 514a, in some embodiments, the bracket 528B can include a support surface 555 configured to reside within a support surface receiving channel 557, defined by the first piece 514a.

One or more flexible arms 556a/b defined by the bracket 528B can be movable from a naturally biased outward position (as depicted in FIGS. 47A/B) to an insertion position, for insertion of the bracket 528B into the bracket mounting channel 550a/550b. Thereafter, the one or more flexible arms 556a/b can be configured to be naturally biased to the outward position to maintain pressure against an interior surface of the bracket mounting channel 550b, thereby maintaining the bracket 528B in position relative to the second piece 514b until the bracket 528B is secured between the first piece 514a and the second piece 514b.

In addition to supporting sensor 520 or fiber optic adapter 546, the brackets can define a mount opening configured to support the coupling of a wide variety of couplings, cables and adapters. In some embodiments, each coupling, cable and adapter can be paired with a unique adapter or size of adapter configured to support the coupling, cable and adapter within the sealing arrangement 510. For example, as depicted in FIGS. 40-41, in some embodiments, a first bracket 528A configured to secure at least a portion of a sensor 520 can be retained between the first piece 514a and the second piece 514b of the axially movable member. In another example, as depicted in FIGS. 45-47B, a second bracket 528B configured to secure at least a portion of a fiber-optic adapter 546 can be retained between the first piece 514a and the second piece 514b of the axially movable member.

In another example, as depicted in in FIG. 52, a third bracket 528C can be used to facilitate installing smaller cables through the cable pass through location of the of the sealing arrangement 510. As depicted, in some embodiments, the bracket 528C can include a central divider 575 positioned between two latching arms 577. The latching arms 577 can be biased toward an outwardly angled orientation and remain in the outwardly angled orientation when at rest. The latching arms 577 are forced inwardly to a generally vertical position when the bracket 528C are installed between the first piece 514a and the second piece 514b of the axially movable member. In some embodiments, the mounting bracket channel 550b can include ramp surfaces that allow the bracket 528C to be pulled from the cable pass through locations without requiring the latching arms 577 to be manually flexed inward. Instead, when the bracket 528C is pulled one or more tabs 579 ride on the ramp surfaces causing the latching arms five is 77 to flex inwardly. In some embodiments, the central divider 575 is configured to pivot toward either of the latching arms 577 to accommodate cables of different size.

In yet other examples, the brackets 528A-C can be removed from the sealing arrangement 510 to enable a larger cable to pass through the cable pass through location of the sealing arrangement 510

With reference to FIGS. 48-51, an exploded view of the fiber-optic adapter 546 configured to enable selective mating of a ruggedized fiber-optic connector 601 (e.g., positioned on an exterior of the closure 500) with a non-ruggedized fiber-optic connector 599 (e.g., positioned within an interior of the closure 500) is depicted in accordance with an embodiment of the disclosure. In embodiments, the fiber-optic adapter 546 is configured to mount within a mount opening 548 defined by the bracket 528B.

In embodiments, the fiber-optic adapter 546 can include a main body 558, having a first end 559 and a second end 560, wherein a length of the fiber-optic adapter 546 extends between the first and second ends 559, 560. In some embodiments, the first end 559 defines a ruggedized connector port 561 (e.g., connectable to a ruggedized fiber-optic connector 601) and can be referred to as the ruggedized end.

In embodiments, the main body 558 can be of a unitary (e.g., single piece), molded construction, which can have a form factor that matches or is otherwise compatible with a ruggedized fiber-optic connector. The second end 560 defines a non-ruggedized connector port 562 (e.g., connectable to a non-ruggedized fiber-optic connector 599) and can be referred to as the non-ruggedized end. In embodiments, the non-ruggedized end can be adapted to receive a non-ruggedized fiber optic connector 599 (e.g., SC or LC type fiber-optic connector or the like).

When the non-ruggedized fiber optic connector 599 is secured to the non-ruggedized connector port 562, and the ruggedized fiber-optic connector 601 is secured to the ruggedized connector port 561, the non-ruggedized fiber-optic connector 599 and the ruggedized fiber-optic connector 601 are optically connected together, such that the ruggedized and non-ruggedized fiber-optic cables are coaxially aligned to provide an optical connection between the optical fibers contained within each of the ruggedized and non-ruggedized fiber-optic cables.

The main body 558 can define an outer flange 563 and exterior threads 564. When the main body 558 is secured within the mounting opening 548 defined through the bracket 528B, the outer flange 563 engages a first side 565 of the bracket 528B, while a nut 566 is threaded onto the exterior threads 564 to engage a second side 567 of the bracket 528B. In this way, the bracket 528B is compressed between the outer flange 563 and the nut 566 to secure the main body 558 to the bracket 528B. In some embodiments, the fiber-optic adapter 546 can further include a gasket or other seal 568 (e.g., configured to abut up against the bracket 528B) when secured within the mount opening 548 to inhibit water and dirt intrusion through the mount opening 548.

In some embodiments, the fiber-optic adapter 546 can include a dust cap 569, which can optionally be tethered to the main body 558 via a lanyard 570. In embodiments, the dust cap 569 can be adapted to be secured over the ruggedized connector port 561 prior to inserting the ruggedized fiber-optic connector 601 therein. It will be appreciated that the dust cap 569 can be removed from the first end 559 of the main body 558 to allow insertion of the ruggedized fiber-optic connector 601.

As depicted in FIG. 50, the ruggedized fiber-optic connector 601 can include a connector core 603 terminating one end of the fiber-optic cable 605. A turn to secure fastener 607 is rotatably mounted on the connector core 603, and a strain relief boot 609 is mounted on the turn to secure fastener 607. The turn to secure fastener 607 mounts on the connector core 603 adjacent to a rear end of the connector core (i.e. adjacent at one end to which the cable is secured). In embodiments, the connector core 603 can include a front plug end 609 positioned opposite from a rear cable attachment end 611. The front plug end 609 optionally has a form factor compatible with an SC type fiber-optic adapter, but could have other form factors as well, such as an LC connector form factor compatible with an LC fiber-optic adapter. The fiber-optic cable 605 is attached are secured to the connector core 603 at the rear cable attachment end 611 of the connector core 603. The fiber-optic cable 605 can include an outer jacket 613. The outer jacket 613 of the fiber-optic cable 605 can be secured to the cable attachment end 611 of the connector core 603 by a sleeve 615, such as a shape memory sleeve (e.g., heat shrink sleeve). In certain examples, the heat shrink sleeve 615 can include an interior layer of adhesive for bonding the heat shrink sleeve to the outer jacket 613 and to the connector core 603. The turn to secure fastener 607 is mounted over the connector core 603 and can be turned (e.g., rotated) relative to the connector core 603 about a longitudinal axis 617. The turn to secure fastener 607 is captured axially between an outer stop 619 (e.g., a shoulder) of the connector core 603 and the front end of the sleeve 615, such that the turn to secure fastener 607 is retained on the connector core 603. The boot optionally can be turned in unison with the turn to secure fastener 607 about the axis 617.

An optical fiber structure 621 includes a first section 623 routed longitudinally through the outer jacket 613 of the fiber-optic cable and a second section 625 routed through the connector core 603. The second section 625 of the optical fiber structure 621 defines a fiber tip 627 at the front plug end 609 of the connector core 607. A front portion of the second section 625 of the optical fiber structure 621 is secured and supported within a ferrule 629. The ferrule 629 is spring biased in a forward direction relative to the connector core 603 by a spring 631. An inner body mounts within the connector core 603, and includes a front end that functions as a spring stop and a rear end that can include structure for use in securing strength members of the fiber-optic cable 605 to the connector core 603.

The coupling arrangement 571 can include two distinct interlock functions, including a first interlock function, including one or more snap fit features 572, adapted to inhibit rotation between the fiber-optic adapter 546 and the ruggedized fiber-optic connector 601, and a second interlock function, including one or more stops 573a/b (e.g., triangular projections, etc.), configured to establish axial retention between the fiber-optic adapter 546 and the turn to secure fastener 607 of the ruggedized fiber-optic connector 601.

Further, in some embodiments, the main body 558 can include a keyway 633 for receiving an elongate key 634 of the connector core 603. The main body 558 also includes internal structure rotationally guiding the keying rail to the keyway 633. In certain examples, the structure for providing rotational guiding can include two helical shoulders that rotate in opposite helical directions about a central longitudinal axis of the main body 558 as the shoulders extend along the axis in a direction from the first end 559 to the second end 560 of the main body 558. In certain examples, the keyway 633 can provide for rotational guiding of the connector core 603 as the connector core 603 is inserted into the ruggedized connector port 561 along a rotational range of movement of at least 90°, or at least 135°, or at least 170°, or about 180°.

As depicted in FIG. 49, in some embodiments, the main body 558 can include an internal sleeve holder 640. In some embodiments, the internal sleeve holder 640 can contain a ferrule alignment sleeve, such as a split sleeve 642 made of an elastic material (e.g., phosphor bronze, zirconia, ceramic, etc.) in certain examples, the internal sleeve holder 640 can include a plurality of fingers that can be flexed open to allow the split sleeve 642 to be inserted within and retained within the internal sleeve holder 640. For example, a ferrule 584 of the non-ruggedized fiber-optic connector 599 can be received within one end of the ferrule alignment sleeve 642 housed within the sleeve holder 640 and the ferrule 629 of the ruggedized connector 601 can be received within the opposite end of the ferrule alignment sleeve 642, thereby coaxially aligning the two ferrules 584, 629 to provide an optical connection between the optical fibers held by each of the ferrules 584, 629.

In certain examples, the fiber-optic adapter 546 further includes a retention collar 574 that mounts over the exterior of the main body 558 adjacent to the first end 559. The retention collar 574 is non-rotatably mounted relative to the main body 558 such that the retention collar 574 cannot be rotated about the central axis of the main body 558. The retention collar 574 is moveable between an extended position and a retracted position. A detent is provided for retaining the retention collar 574 in the extended position and in the retracted position. When the retention collar 574 is moved to the extended position while a ruggedized fiber optic cable is in a coupled rotational position relative to the fiber-optic adapter 546, retaining member (e.g., fingers) inside the retention collar 300 extend within the interior of the ruggedized fiber optic cable and oppose the stop surfaces of the interior coupling arrangement of the ruggedized fiber optic cable. In this way, the retention collar 574 prevents the ruggedized fiber optic cable from being rotated from the coupled rotational position back to the non-coupled rotational position. In contrast, when the retention collar 574 is moved to the retracted position, the retaining members 305 disengage from the stop surfaces thereby allowing the ruggedized fiber optic cable to be rotated from the coupled rotational position back to the non-coupled rotational position when sufficient torque is applied to the turn-to-secure fastener to overcome the detent 572 and move the ruggedized fiber optic cable from the coupled rotational position back to the non-coupled rotational position.

In certain examples, the retention collar 574 can be spring biased toward the extended position. In this way, the retention collar 574 can automatically move from the retracted position to the extended position once the ruggedized fiber optic cable is turned from the non-coupled rotational state to the coupled rotational state. To de-couple the ruggedized fiber optic cable, the collar 574 can be manually slid from the extended position to the retracted position against the bias of the spring to allow for rotation of the ruggedized fiber optic cable from the coupled rotational state to the non-coupled rotational state. Insertion of the ruggedized fiber optic cable into the fiber-optic adapter 546 can cause movement of the collar 574 from the extended position to the retracted position (e.g., via physical contact between the retaining sleeve and the core assembly) against the bias of the spring.

Accordingly, the sealing arrangement 510 includes first and second axially movable member 514, 516 that are separable to allow a fiber optic adapter 546 to be loaded between the first and second axially movable member 514, 516. The sealing arrangement 510 includes sealing gel block 512 contained between first and second axially movable member 514, 516. The first and second axially movable member 514, 516 are adapted to interlock with inner and outer pressurization structures of an actuator 506 used to pressurize the gel 512 between the first and second axially movable member 514, 516. The first and second axially movable member 514, 516 define cable receiving locations (e.g., notches, openings) for routing cables through the first and second axially movable members 514, 516 and through the gel 512. A cable pass-through orientation (e.g., fiber optic adapter 546) extends transversely between the first and second axially movable members 514, 516 and through a thickness of the gel 512 defined between the first and second axially movable members 514, 516. The sealing arrangement 510 is adapted to force the first and second axially movable members 514, 516 together in an orientation along the cable pass-through axis to pressurized the gel 512 within the sealing arrangement 510 to provide sealing. In one example, the first and second axially movable members 514, 516 each generally form half-portions 514a/b and 516a/b of a the sealing arrangement 510. When assembled the half-portions 514a/b and 516a/b mechanically engage each other (e.g., include engagement portions that overlap, or engagement portions that mate, etc.) to allow load to be transferred in both directions along the cable pass-through orientation between the first and second axially movable members 514, 516 to define the full gel block 512 volume of the sealing arrangement 510.

Having described the preferred aspects and implementations of the present disclosure, modifications and equivalents of the disclosed concepts may readily occur to one skilled in the art. However, it is intended that such modifications and equivalents be included within the scope of the claims which are appended hereto.

1. A sensor system comprising: a sealed fiber optic closure; a sensor within the sealed fiber optic closure for detecting activity at the sealed fiber optic closure, such as whether the sealed fiber optic closure has been opened and/or whether movable components within the sealed fiber optic closure are moved.

2. The sensor system of claim 1, where the sensor system includes a controller to monitor authorized movements with respect to the sealed fiber optic closure, such as opening and closing the sealed fiber optic closure, or moving components within the sealed fiber optic closure, by a technician.

3. The sensor system of claim 1, where the sensor system includes a controller to monitor unauthorized movements with respect to the sealed fiber optic closure, such as opening and closing the sealed fiber optic closure, or moving components within the sealed fiber optic closure, and generating an alarm signal.

4. The sensor system of claim 1, wherein the sensor is an optical sensor, in particular an optical sensor capable of sensing mechanical movement, and an optical sensor assembly and a monitoring device having the optical sensor, wherein the optical sensor uses an OTDR signal for sensing mechanical movement, and communicating the mechanical movement to a remote location, such as a central office.

5. The sensor system of claim 1, wherein the sensor includes a base and a sensing component movable relative to the base, and wherein the sensing component extends into gel sealing the sealed fiber optic closure.

6. The sensor system of claim 5, wherein the sensing component is configured to move relative to the base between a non-actuated position and an actuated position when the gel is axially compressed between two pressure plates.

7. The sensor system of claim 5, further comprising a counterpart extending into the gel and opposing the sensing component.

8. The sensor system of claim 7, wherein the counterpart is spaced from the sensing component by the gel.

9. The sensor system of claim 7, wherein the counterpart is spring biased towards the sensing component.

10. The sensor system of claim 1, further comprising: an exterior optical sensor disposed outside of the sealed fiber optic closure; and a detection fiber extending from the exterior optical sensor to an interior of the sealed fiber optic closure.

11. A sealing arrangement including a fiber-optic connection comprising:
a sealing arrangement, including a first pressure plate, a second pressure plate, a gel block, wherein the first pressure plate is configured to axially shift towards the second pressure plate to deform the gel block; and
one or more brackets configured to be selectively received by the first pressure plate, the one or more brackets defining at least one of (i) a mount opening configured to receive an optical sensor, (ii) a mount opening configured to receive a fiber-optic adapter operably couplable to a ruggedized connector of a fiber optic cable, or (iii) a pass through opening configured to receive a pair cables positioned on opposing sides of a central divider.

12. The sealing arrangement of claim 11, wherein the first pressure plate includes a first piece and a second piece.

13. The sealing arrangement of claim 12, wherein the one or more brackets are configured to be received in a bracket mounting channel defined within the first piece and the second piece.

14. The sealing arrangement of claim 13, wherein the one or more brackets define an alignment tab configured to be received within an alignment groove of the first piece.

15. The sealing arrangement of claim 14, wherein the one or more brackets define a support surface configured to be received within a support surface receiving channel of the second piece.

16. The sealing arrangement of claim 11, wherein the one or more brackets define one or more flexible arms configured to aid in retention of the one or more brackets within the first pressure plate.

17. The sealing arrangement of claim 11, wherein the fiber-optic connection defines a non-ruggedized connector port and a ruggedized connector port.

18. The sealing arrangement of claim 17, wherein the non-ruggedized connector port is adapted to receive at least one of a non-ruggedized SC or LC connector.

19. The sealing arrangement of claim 18, wherein the ruggedized connector port is adapted to receive a pre-terminated fiber optic cable.

20. The sealing arrangement of claim 19, wherein the ruggedized connector port provides a first interlock function and a second interlock function.

21. The sealing arrangement of claim 20, wherein the first interlock function includes a snap-fit feature adapted to engage with a ramped snap-fit feature of the pre-terminated fiber optic cable, wherein as the pre-terminated fiber optic cable is rotated relative to the fiber-optic adapter, the snap-fit feature of the pre-terminated fiber optic cable rides over the snap-fit feature of the fiber-optic adapter causing the snap-fit feature to deflect radially inwardly to allow the ramped snap-fit feature to move past the snap-fit feature, whereupon the pre-terminated fiber optic cable reaches a coupled rotational position and the ramped snap-fit feature moves past the snap-fit feature such that the snap-fit feature elastically returns to its non-deflected position.

22. The sealing arrangement of claim 20, wherein the second interlock function includes a plurality of triangular projections spaced uniformly along a circumference of a first end.

23. The sealing arrangement of claim 11, wherein a main body of the fiber-optic connection passes through the mount opening of the one or more brackets, wherein the one or more brackets are compressed between a flange defined by the main body and a nut threaded on an exterior threaded portion defined by the main body.

24. The sealing arrangement of claim 11, further comprising a dust cap adapted to be secured over a first end of main body of the fiber-optic connection to selectively enclose a ruggedized connector port.
